(19) United States
(12) Patent Application Publication
(10) Pub. No.: US 2026/0027013 A1
(43) Pub. Date: Jan. 29, 2026

(54) ADAPTIVE PACIFIER ASSEMBLY AND METHOD FOR LIQUID FOOD AND MEDICATION DELIVERY TO CHILDREN

(71) Applicant: Papeltec Overseas, Inc., Atlantic Beach, FL (US)

(72) Inventors: Victor Rodriguez, Jacksonville, FL (US); Peter A. Rodriguez, Jacksonville, FL (US)

(73) Assignee: Papeltec Overseas, Inc., Atlantic Beach, FL (US)

(21) Appl. No.: 19/020,888

(22) Filed: Jan. 14, 2025

Related U.S. Application Data
(60) Provisional application No. 63/675,157, filed on Jul. 24, 2024.

(51) Int. Cl. A61J 17/00

(52) U.S. Cl. CPC A61J 17/105; A61J 17/001

(57) ABSTRACT

The present invention provides an innovative baby pacifier apparatus, system, and methods for feeding liquid food or medicine to infants. The pacifier comprises a protective guard with a detachable nipple on one side and a detachable food storage chamber or ring on the other. The system includes interchangeable components such as food pouches, feeding tubes, and protective caps, allowing customization based on the infant's needs. A feeding tube connects the pacifier to a liquid pouch via a connector. A flow controller, including a drip chamber in the feeding tube, enables caregivers to regulate the liquid flow rate for safe and efficient delivery. The food storage chamber, fillable through one or more ports, includes flow control valves for releasing liquid when the infant sucks on the nipple. Protective caps attach to the nipple and storage chamber for hygiene, offering a flexible, safe, and convenient solution for feeding in various settings.

### CROSS REFERENCE TO RELATED APPLICATIONS

This application claims the benefit of U.S. Provisional Application No. 63/675,157, filed, Jul. 24, 2024, and entitled APPARATUS, SYSTEM, AND METHOD FOR ADMINISTERING A LIQUID TO A CHILD THROUGH A PACIFIER, the entire disclosure of which is incorporated herein by reference.

### FIELD OF THE INVENTION

The present invention relates to baby pacifiers, and more particularly, to a modular pacifier system designed to facilitate feeding infants with liquid food, milk, medicine, baby formula, or other consumable liquids. The invention provides a pacifier assembly with interchangeable components, including various sizes of nipples, food storage chambers, feeding tubes, and protective caps, allowing caregivers to customize the pacifier to suit an infant's feeding needs. Additionally, the invention provides a method for delivering liquid to a child through controlled flow mechanisms, offering flexibility and safety in administering liquids in a hygienic, convenient, and portable manner. The invention provides a practical and comforting solution for caregivers so that children receive nutrients and medication efficiently and safely through a familiar and soothing pacifier.

### BACKGROUND OF THE INVENTION

Pacifiers, also known as soothers, dummies, or binkies, are widely used to calm and soothe infants. They typically consist of a nipple made from latex, silicone, or rubber, a shield to prevent swallowing, and a handle or ring for easy handling. Pacifiers mimic the act of breastfeeding and help satisfy the natural sucking reflex in babies, which can be soothing and comforting. Pacifiers are also commonly used as a means to reduce crying, promote sleep, and provide comfort in unfamiliar environments.

Current pacifiers come in various designs and types, each catering to specific needs and preferences. Orthodontic pacifiers are constructed to support the natural development of a baby's teeth and gums, featuring a flat bottom and rounded top to mimic the shape of a mother's nipple during breastfeeding. One-piece pacifiers are molded from a single piece of material, reducing the risk of parts breaking off and posing a choking hazard. Multi-piece pacifiers consist of separate components, typically a nipple, a shield, and a handle, which can sometimes pose a risk if parts become detached.

Despite their widespread use and benefits, traditional pacifiers are limited in function to provide comfort through sucking. Feeding infants with nutrient-rich food, medicine, baby formula, or water often requires a separate process. This separation can create several challenges for caregivers. Infants are sometimes resistant to drinking milk or taking medicine directly from a bottle or spoon, leading to struggles and stress during feeding times. For example, a child who refuses to drink milk may miss out on essential nutrients needed for growth and development.

Administering medicine to infants poses another significant challenge. Babies often resist taking medicine due to the unfamiliar taste and texture, which can lead to incomplete doses and ineffective treatment. Caregivers may try to mix medicine with food or drink, but this can be impractical and may not ensure that the child consumes the full dose. In addition, some medicines may have an unpleasant taste that cannot be easily masked, making administration even more difficult. For infants with specific medical needs, such as those requiring regular doses of medication, the lack of an effective and reliable administration method remains a substantial concern.

Traditional methods of feeding and medicating infants often require holding the child in a specific position, using a separate bottle or spoon, and managing the child's resistance, all of which can be cumbersome and time-consuming. This can be particularly challenging during times when a child is already distressed or unwell, as their resistance to feeding and medication can increase.

Current solutions include various types of specialized bottles and syringes constructed to case the process of feeding and medicating infants, but these tools still face limitations. Bottles with integrated medicine dispensers can help, but they do not address the issue of a child's reluctance to accept the bottle. Similarly, syringes constructed to squirt medicine into the back of a baby's mouth can be effective but often require careful handling to avoid gagging or choking, and may still meet with resistance. Additionally, these tools often lack portability, making it challenging for caregivers to manage feeding and medication administration while on the go.

Pacifier feeders, which combine a pacifier with a small reservoir for holding food or medicine, offer a partial solution by leveraging the soothing nature of pacifiers to administer substances. However, these designs often suffer from limited capacity and may not effectively control the flow of the liquid, leading to potential choking hazards or spillage. Additionally, these feeders often lack mechanisms to prevent the liquid from dripping out when not in use, making them less practical and hygienic.

One of the main drawbacks of current pacifier feeders is their inability to control the dosage and flow rate of the administered liquid. This is particularly important for medicine, where precise dosing is critical. Inconsistent flow rates can lead to either under-dosing or over-dosing, both of which can have serious consequences. Furthermore, the lack of a robust flow control mechanism can make these feeders less reliable and harder to use effectively.

Another challenge is the cleaning and sterilization of these multi-component systems. Traditional pacifiers are relatively simple to clean and sterilize due to their straightforward design. However, pacifier feeders, with their additional components like reservoirs and valves, can be more difficult to clean thoroughly. This increases the risk of bacterial growth and infection, which is particularly concerning for young children with developing immune systems.

Feeding children with solid foods introduces another set of challenges. While pacifiers can be used to calm children, transitioning them to solid foods often involves different tools and methods. Traditional baby food feeders, which consist of a mesh or silicone pouch attached to a handle, allow children to suck or chew on solid foods without the risk of choking. However, these feeders can be messy and difficult to clean, and they do not address the need for feeding liquid nutrients or medicine.

Moreover, the traditional pacifiers and pacifier feeders do not account for the varying needs of different age groups and developmental stages. Infants and young children have different sucking strengths and feeding needs, and a one-size-fits-all approach may not be effective. Customized solutions that can adapt to a child's growth and changing needs would be more beneficial but are not widely available in current products. For example, an older infant might require a larger liquid volume or a slower flow rate adjustment than a newborn. A pacifier system that offers adjustable flow rates, different nipple shapes, and sizes could better cater to these diverse developmental needs.

The development of an integrated pacifier system that combines the soothing effect of a traditional pacifier with a reliable, controlled method for administering liquids may address many of these challenges. Such a system may need to provide precise dosing, easy cleaning, and a secure, leak-proof design. Incorporating advanced materials and engineering can further enhance the safety and functionality of the product, providing a comprehensive solution for caregivers.

Innovations in this area can also explore the use of sensors and smart technology to monitor and adjust the flow of liquids based on the child's sucking patterns. This may be helpful that the child receives the appropriate amount of liquid at a comfortable rate, reducing the risk of choking and improving the overall feeding experience. Additionally, integrating alert systems that notify caregivers when the liquid reservoir is low or if there are any blockages, can further enhance the reliability and convenience of the system.

In conclusion, while current pacifiers and feeding tools provide essential functions, they often fall short in addressing the combined needs of soothing, feeding, and medicating infants and young children. The development of a more advanced pacifier system that integrates these functions can significantly improve the ease and effectiveness of caring for young children, offering a practical solution to the challenges faced by caregivers.

### SUMMARY OF THE INVENTION

Accordingly, the present invention provides an apparatus, system, and method for feeding infants and young children through a pacifier. The invention integrates a traditional pacifier with a specialized feeding mechanism that allows for the controlled delivery of liquid food, medicine, baby formula, breast milk, or water. This integration aims to overcome the challenges associated with feeding and medicating infants by leveraging the calming and familiar nature of a pacifier while providing a practical and efficient means of liquid administration. The system additionally aims to address diverse dietary and medicinal needs by providing a versatile feeding platform capable of delivering a variety of liquid and semi-liquid substances, enhancing the pacifier's role beyond simple soothing.

The primary components of the invention may include a pacifier with a soft, flexible nipple, a safety-enhanced protective guard, and ring or a food storage chamber, a feeding line, a connector (e.g., a piercing connector or a detachable connector, such as a luer lock connecter), a liquid container, and a flow controller. The nipple may be constructed to mimic the feel and function of a mother's breast, providing a soothing and natural experience for the infant. The protective guard prevents the pacifier from being fully inserted into the child's mouth, providing safety, while the ring allows for easy handling and attachment to pacifier clips or holders. In some embodiments, the nipple may be interchangeable to accommodate different flow rates or age-appropriate sizes, offering further customization based on the infant's developmental needs.

In some embodiments, the traditional ring of the pacifier may be replaced with a small, secure container/feeder/chamber constructed to hold various soothing liquids. This innovative feature allows caregivers to provide a range of comforting options for infants, including honey, fruit purees (such as apple or banana), maple syrup, agave nectar, and mild herbal infusions like chamomile tea. Additionally, the container may be used for pediatric electrolyte solutions, coconut water, or even vegetable juices like carrot or beet juice. This multifunctional design not only enhances the pacifier's utility but also offers a delightful experience for infants, promoting both hydration and nutrition in a safe and convenient manner. The design further includes leak-resistant scaling mechanisms for clean and efficient use, especially when the pacifier is being used on-the-go or stored in a diaper bag.

The feeding line is a flexible, medical-grade tube that connects the pacifier to the liquid container. It may be constructed to allow the liquid to flow smoothly from the container to the nipple, so that the infant can draw the liquid while sucking on the pacifier. The connector allows for secure and sterile attachment to the liquid container, preventing leaks and contamination. The connector may comprise a sharp tip similar to those used in IV glucose setups. In some embodiments, the connector may be constructed as a piercing connector, a Luer lock connector, or another type of connector with similar functionalities, such as snap-fit, friction-fit, or threaded connections. This versatility allows for secure and reliable attachment, accommodating various applications while maintaining safety and case of use. An additional locking mechanism may be incorporated into the connector to prevent accidental detachment during feeding sessions.

In some embodiments of the present invention, the liquid container may be constructed to hold various types of liquids, including milk, juice, water, or medicine. The container can be made from materials that are safe for infants, such as BPA-free plastic or medical-grade silicone. It may be constructed to be easily replaceable, allowing caregivers to switch between different liquids as needed. In some embodiments, the container may be a refillable container, easy to wash after every use. The container may also be designed with graduated markings to help caregivers accurately measure and monitor the infant's intake, providing precise dosing especially when administering medication.

In some embodiments, the flow controller may be integrated into the feeding line. The controller can be adjusted to regulate the flow of liquid from the container to the pacifier, allowing that the infant receives an appropriate amount of liquid without the risk of choking. The flow controller can be a simple valve or a more sophisticated mechanism that automatically adjusts based on the infant's sucking patterns. In some embodiments, the flow controller can be constructed similarly to an intravenous (IV) controller used in medical glucose or drip assemblies. This type of flow controller typically consists of a clamp or a dial mechanism that can be adjusted to control the rate at which the liquid flows through the feeding line. By integrating this IV-style flow controller into the feeding system, caregivers can achieve precise control over the flow rate of liquid food, medicine, or water being administered to the infant. Some flow controllers may comprise digital adjustment options that allow for highly precise control, especially useful for medical or high-nutrient liquids.

The IV-style flow controller offers several advantages, including ease of use and precise regulation. Caregivers can simply adjust the clamp or dial to increase or decrease the flow rate, allowing that the infant receives the correct amount of liquid at a comfortable pace. This level of control is particularly beneficial when administering medication, where precise dosing is important.

In some embodiments, the flow controller may comprise a drip chamber, similar to those used in IV tubing, allowing caregivers to visually monitor the flow of liquid food, medication, or water. The drip chamber is a transparent section of the feeding line that enables caregivers to see the liquid dripping through the system, providing a clear visual indication of the flow rate and that the liquid is being administered correctly. Additionally, the drip chamber may be fitted with a flow indicator, such as a small rotor, to further assist caregivers in monitoring flow continuity.

In some embodiments, the pacifier system may include a sensor that monitors the flow rate and alerts the caregiver if the flow is too fast or too slow. This sensor can be connected to a mobile app, providing real-time notifications, and allowing caregivers to make adjustments as needed. The app can also track the amount of liquid consumed, helping caregivers monitor the infant's intake of nutrients and medication. The mobile app may additionally support logging of feeding sessions, enabling caregivers to track patterns and consult pediatricians with precise intake data when necessary.

The invention also provides methods for feeding infants and young children using the pacifier system. In some embodiments, a method involves filling the liquid container with the desired liquid, attaching the feeding line using the connector, adjusting the flow controller, and allowing the infant to suck on the pacifier. The method comprises delivering the liquid in a controlled and safe manner, making feeding and medicating easier for caregivers and more comfortable for infants.

In some embodiments of the present invention, the pacifier system may include a warming element that keeps the liquid at a comfortable temperature. This element can be integrated into the container or the feeding line and can be powered by a small battery or a plug-in adapter. The warming element keeps the liquid warm (or at desired a temperature), providing additional comfort for the infant and making the feeding experience more pleasant.

Another embodiment may include a detachable reservoir that can be filled with liquid and attached to the feeding line as needed. This reservoir can be pre-filled and stored in a refrigerator or diaper bag, allowing caregivers to prepare multiple feeds in advance and reduce the time spent preparing each feeding session. The detachable reservoir may also make it easier to clean and sterilize the components, helping to maintain the system's hygiene. The reservoir may also come in varying capacities to suit different feeding needs and provide compatibility with standard sterilization practices.

In further embodiments, the pacifier system may be constructed to be compatible with standard baby bottles and nipples. This compatibility allows caregivers to use the system with existing feeding equipment, reducing the need for additional purchases and simplifying the feeding process. The system can be easily attached to most bottles, making it versatile and convenient for different feeding scenarios. Additionally, compatibility with standard equipment offers caregivers flexibility in selecting bottle brands or types, accommodating personal preferences and accessibility.

Some embodiments of the invention may comprise an ergonomic design that makes it easy for caregivers to handle and use the pacifier system. The components are constructed to be lightweight and easy to assemble, with clear markings and instructions to guide the user or caregiver. The ergonomic design allows the system to be used comfortably and efficiently, even during long feeding sessions. Such a design can reduce strain on the caregiver's hands and may include non-slip grips or textured surfaces to enhance handling.

In another embodiment, the pacifier system may include a protective cap that covers the nipple when not in use. The protective cap prevents dirt and bacteria from contaminating the nipple, allowing it to remain clean and safe for the infant. The cap can be attached to the ring when the pacifier is in use, preventing it from being lost or misplaced. In some configurations, the cap may feature a secure locking mechanism that prevents accidental opening, adding a further layer of sanitation.

In yet another embodiment, the feeding line may be constructed to be flexible and kink-resistant, allowing the liquid to flow smoothly without interruptions. The feeding line can be made from medical-grade silicone or another safe, durable material that withstands repeated use and sterilization. The kink-resistant design allows the liquid to be delivered consistently, even if the feeding line is bent or twisted.

The pacifier system can also be constructed with a variety of aesthetic options, including different colors and patterns. This customization allows caregivers to choose a design that appeals to their child, making the pacifier more attractive and engaging. The aesthetic options can also include themed designs, such as animals or characters, to further enhance the appeal of the pacifier. Customization may also extend to various pacifier shapes and textures, providing a sensory experience that aligns with the infant's developmental needs.

In some embodiments of the invention, the pacifier system may include a built-in timer that helps caregivers track the duration of each feeding session. The timer can be integrated into the flow controller or the ring and can provide audible or visual alerts when the feeding session is complete. The built-in timer allows the infant to receive an appropriate amount of liquid without overfeeding. The timer feature may be programmable to accommodate different feeding durations, helping establish feeding routines that suit the infant's specific requirements.

Another embodiment may include a night-light feature that illuminates the pacifier, making it easier to use during nighttime feedings. The night-light can be integrated into the ring or the protective guard and can be activated with a simple touch or button press. The night-light provides a soft glow that helps caregivers see the pacifier and feeding line without disturbing the infant's sleep. The night-light may also be equipped with multiple brightness settings, allowing caregivers to adjust the intensity based on ambient lighting.

In further embodiments, the pacifier system may be constructed to be easily disassembled for cleaning and sterilization. The components can be separated and cleaned individually, so that all parts are thoroughly sanitized. This design reduces the risk of bacterial growth and allows the pacifier to remain safe and hygienic for repeated use. Quick-release mechanisms may be integrated into the components to facilitate easier disassembly and reassembly, streamlining the cleaning process.

Some embodiments may include a clip or strap that attaches the pacifier to the infant's clothing, preventing it from being dropped or lost. The clip can be constructed to detach easily in case of excessive force, providing infant's safety. The strap can be made from soft, durable material that is comfortable for the infant to wear. In certain designs, the strap may be adjustable, allowing caregivers to customize the length according to the infant's activity level, thereby preventing entanglement.

In another embodiment, the pacifier system may include a built-in music player that plays soothing sounds or lullabies. The music player can be integrated into the ring or the protective guard and can be controlled with buttons or a mobile app. The built-in music player provides additional comfort for the infant and can help soothe them during feeding sessions. Additionally, the player may offer a variety of sound settings, such as white noise or nature sounds, to cater to different preferences, and an auto-timer to stop playback after a certain period.

In some embodiments, the pacifier system may be constructed to be used with specialized liquids, such as electrolyte solutions or fortified milk. These specialized liquids can provide additional nutrients or hydration for the infant, making the pacifier system a versatile tool for various feeding needs. The system can be adapted to accommodate different types of liquids, allowing the infant to receive nutrients and hydration.

In further embodiments, the pacifier system may include an anti-colic feature that reduces the risk of air ingestion. This feature can be integrated into the feeding line or the nipple and can help prevent gas and discomfort for the infant. The anti-colic feature allows the liquid to be delivered smoothly and without air bubbles, providing a more comfortable feeding experience.

Some embodiments of the invention may comprise a sterilization indicator that changes color when the components have been properly sterilized. This indicator can be integrated into the nipple or the ring and provides a visual confirmation that the pacifier system is safe for use. The sterilization indicator allows caregivers to confidently use the pacifier without worrying about bacterial contamination. To further enhance safety, the indicator may include multiple stages to show whether additional cleaning steps are required, such as ‘Needs Cleaning,’ ‘In Progress,’ and ‘Sterilized.’

Another embodiment may include a feature that allows the pacifier system to be used with multiple infants. The components can be easily disassembled and reassembled with different nipples and feeding lines, making the system versatile and cost-effective for families with multiple children. This feature allows that each infant receives a clean and hygienic pacifier system tailored to their needs. In such embodiments, multiple pacifiers can be connected to a single feeding line or a single liquid container. In some designs, each pacifier may also have color-coded components to easily identify which setup belongs to each child, enhancing hygiene management in multi-child environments.

In some embodiments, the pacifier system may include a travel case that protects the components during transport. The travel case can be constructed to hold the pacifier, feeding line, container, and other accessories, helping the system to remain clean and organized. The travel case makes it easy for caregivers to bring the pacifier system on the go, providing a convenient solution for feeding and medicating infants while traveling.

In further embodiments, the pacifier system may include a feature that tracks the infant's feeding habits and provides insights to the caregiver. This feature can be integrated into the mobile app and can analyze data such as the frequency and duration of feedings, the amount of liquid consumed, and the type of liquid used. The tracking feature may provide valuable information that can help caregivers understand and manage the infant's feeding needs more effectively.

Some embodiments may include a feature that allows caregivers to customize the pacifier system based on the infant's age and developmental stage. This customization can include different nipple shapes and sizes, flow rates, and liquid containers. The ability to customize the pacifier system allows it to be adaptable to an infant's changing needs, providing a consistent and comfortable feeding experience. Customization may further include age-appropriate patterns or colors, encouraging engagement and supporting sensory development as the infant grows.

In another embodiment, the pacifier system may include a feature that allows for the gradual transition from liquid to solid foods. This feature can include interchangeable components, such as a mesh feeder attachment that allows the infant to chew on small pieces of solid food safely. The gradual transition feature helps infants develop their chewing skills while providing a familiar and comforting experience. This transition feature may also include stages to accommodate different food textures, from purees to small solid bites, supporting the infant's progressive development of chewing and swallowing abilities.

In some embodiments, the pacifier system may include a feature that allows caregivers to administer probiotics or other supplements. This feature can be integrated into the liquid container or the feeding line and can provide that the supplements are delivered in the correct dosage. The ability to administer probiotics or supplements provides additional health benefits for the infant, supporting their overall well-being. In certain configurations, the pacifier may include a pre-measured compartment to simplify dosage, so that the infant receives a precise amount of supplement with each feeding.

Another embodiment may include a feature that allows the pacifier system to be used with special dietary requirements, such as hypoallergenic or lactose-free liquids. This feature allows the pacifier system to accommodate infants with specific dietary needs, providing a safe and effective feeding solution for all children.

In further embodiments, the pacifier system may include a feature that allows caregivers to mix different liquids directly in the container. This feature can include a built-in mixer or agitator for thoroughly combining the liquids before feeding. The ability to mix liquids directly in the container provides convenience and flexibility for caregivers, making it easier to prepare customized feeds for the infant.

Some embodiments of the invention may include a feature that allows the pacifier system to be used with different feeding positions. The feeding line can be constructed to be flexible and adjustable, allowing the caregiver to hold the infant in various positions while feeding. The ability to use different feeding positions allows the pacifier system to accommodate the infant's preferences and provide a comfortable feeding experience.

In another embodiment, the pacifier system may include a feature that allows for the attachment of teething toys or other accessories. This feature can be integrated into the ring or the protective guard and provides additional stimulation and comfort for the infant. The ability to attach teething toys or accessories makes the pacifier system a multifunctional tool that supports the infant's development and well-being.

In some embodiments, the pacifier system may include a feature that allows caregivers to monitor the temperature of the liquid. This feature can be integrated into the feeding line or the container and can provide real-time temperature readings indicating that the liquid is at a safe and comfortable temperature for the infant. Another embodiment may include a feature that allows the pacifier system to be used with different types of liquids, such as thickened liquids for infants with swallowing difficulties.

In further embodiments, the pacifier system may include a feature that allows caregivers to program specific feeding schedules. This feature can be integrated into the mobile app and can provide reminders and alerts for feeding times. Some embodiments of the invention may include a feature that allows the pacifier system to be used with different types of nipples, such as slow-flow or fast-flow nipples. The feeding schedule feature may also suggest customized feeding intervals based on the infant's age and health requirements, adapting to growth and changing dietary needs.

In some embodiments, the pacifier system may include a feature that allows for the storage of multiple liquid containers. This feature can be integrated into the travel case or a separate storage unit and allows caregivers to have access to a ready supply of liquid containers for feeding. The ability to store multiple liquid containers provides convenience and efficiency, making it easier to manage feeding and medication needs. Another embodiment may include a feature that allows the pacifier system to be used with different types of liquid containers, such as disposable or reusable containers. To further provide hygiene, each container may come with individual, airtight seals to prevent contamination, especially during travel.

In further embodiments, the pacifier system may include a feature that allows for the monitoring of the infant's sucking patterns. This feature can be integrated into the nipple or the feeding line and can provide data on the frequency and strength of the infant's sucking. The ability to monitor sucking patterns provides valuable insights into the infant's feeding behavior and can help caregivers identify any potential issues. Some embodiments of the invention may include a feature that allows the pacifier system to be used with different types of feeding lines, such as insulated or heated lines. Insights from the sucking pattern analysis can further assist in customizing feeding routines and may also help in early detection of potential feeding-related developmental concerns.

In some embodiments, the pacifier system may include a feature that allows for the customization of the flow controller. This feature can include different settings or modes that allow caregivers to adjust the flow rate based on the infant's needs. The ability to customize the flow controller allows the pacifier system to provide a tailored feeding experience for each child. Another embodiment may include a feature that allows the pacifier system to be used with different types of liquid containers, such as glass or stainless steel. Additional modes may include a ‘Lock’ feature to prevent accidental changes in flow rate, maintaining safety and consistency during feeding.

In further embodiments, the pacifier system may include a feature that allows for the integration of a liquid level indicator. This feature can be integrated into the container or the feeding line and provides real-time readings of the liquid level. Some embodiments of the invention may include a feature that allows the pacifier system to be used with different types of liquid additives, such as vitamins or minerals. Another embodiment may include a feature that allows the pacifier system to be used with different types of feeding accessories, such as bibs or burp cloths. The liquid level indicator may also include visual alerts, such as a light-up feature, to signal when the container is running low, reducing the risk of unexpected interruptions during feeding.

Some embodiments of the invention may include a feature that allows the pacifier system to be used with different types of liquid delivery methods, such as gravity-fed or pump-assisted. In another embodiment, the pacifier system may include a feature that allows for the integration of a safety lock. This feature can be integrated into the flow controller or the ring and allows the liquid flow to be securely stopped when not in use. The safety lock feature provides additional peace of mind, preventing accidental spills or overfeeding.

In further embodiments, the pacifier system may include a feature that allows for the integration of a feeding schedule tracker. This feature can be integrated into the mobile app and provides reminders and alerts for feeding times, so that the infant receives regular and consistent feedings. Some embodiments of the invention may include a feature that allows the pacifier system to be used with different types of flow controllers, such as manual or automatic. In some embodiments, the pacifier system may include a feature that allows for the integration of a liquid flow sensor. This feature can be integrated into the feeding line or the nipple and provides real-time readings of the liquid flow rate. The schedule tracker may also allow for shared access, enabling multiple caregivers to coordinate and track feeding times efficiently.

Some embodiments of the invention may include a feature that allows the pacifier system to be used with different types of nipple shapes, such as round or orthodontic. In another embodiment, the pacifier system may include a feature that allows for the integration of a multi-chamber container. This feature can be integrated into the liquid container and provides separate compartments for different liquids, allowing the liquids to not mix until needed. Each chamber in the container may be equipped with individual flow controls, giving caregivers the option to mix liquids selectively or maintain them separate, based on the infant's needs.

In some embodiments, the pacifier system may include a feature that allows for the customization of the feeding line length. This feature allows the pacifier system to accommodate different feeding positions and preferences, providing a flexible and effective feeding solution. Another embodiment may include a feature that allows the pacifier system to be used with different types of liquid containers, such as collapsible or expandable containers. Customization of feeding line length can also incorporate easy-to-use length adjustment clips, enabling quick modifications based on specific feeding setups or positions.

In some embodiments, multiple feeding lines can be connected to a single liquid container, allowing the system to feed multiple children simultaneously. This setup is particularly useful in environments such as daycare centers or homes with twins or multiple young children. The liquid container can be constructed with multiple ports or connectors, each accommodating a separate feeding line. Each feeding line can then be routed to an individual pacifier, allowing that each child has their own dedicated feeding apparatus. In some embodiments, each feeding line can be equipped with an individual flow controller, enabling caregivers to adjust the flow rate for each child according to their specific needs.

### BRIEF DESCRIPTION OF THE DRAWINGS

FIG. 1 illustrates a schematic diagram of a baby pacifier comprising a feeding line directly attached to a nipple or a protective guard, according to some embodiments of the present invention.

FIG. 1A illustrates another schematic variation of a baby pacifier comprising a feeding line connected to a liquid storage chamber, according to some embodiments of the present invention.

FIG. 2 illustrates an exemplary baby pacifier connected to a liquid container in some implementations of the present invention.

FIG. 3 illustrates a schematic diagram of an exemplary baby pacifier system comprising a flow controller in the feeding line.

FIG. 4 illustrates exemplary method steps that can be performed according to the present invention.

FIG. 5 illustrates an exemplary baby pacifier comprising a storage chamber with one or more inlets in some embodiments of the present invention.

FIG. 5A illustrates an exemplary baby pacifier comprising a flow control valve in a protective guard in some embodiments of the present invention.

FIG. 5B illustrates an exemplary method of filling a food storage chamber of a baby pacifier using a syringe in some embodiments of the present invention.

FIG. 5C illustrates an exemplary modular baby pacifier comprising removably attachable parts in some implementations of the present invention.

FIG. 6 illustrates an exemplary baby pacifier comprising a multi-port connector for connecting multiple feeding lines from different food pouches to a baby pacifier in some implementations of the present invention.

FIGS. 7 and 7A illustrate exemplary baby pacifiers comprising protective caps for food storage chambers and nipples in some implementations of the present invention.

FIG. 8 illustrates different variations and sizes of baby pacifiers, food pouches, and feeding tubes in some embodiments of the present invention.

FIGS. 9A-9B illustrate an exemplary flowchart of additional method steps that can be performed in some implementations of the present invention.

### DETAILED DESCRIPTION OF THE INVENTION

The present invention provides an innovative pacifier system constructed to facilitate the feeding of infants and young children with liquid food, medicine, baby formula, breast milk, or water. The system integrates a traditional pacifier with a sophisticated feeding mechanism, allowing for the controlled and efficient delivery of liquids while maintaining the soothing benefits of a pacifier.

In some embodiments, the present invention provides a modular baby pacifier for feeding liquid food or medicine to an infant comprises a protective guard, a detachable nipple, a detachable food storage chamber, a feeding tube, and flow control components. The protective guard is designed to prevent full insertion into the infant's mouth, enhancing safety and providing a stable surface against which the pacifier rests. The protective guard features a first side and a second side, each configured to accommodate various detachable components to customize the pacifier according to the infant's age and feeding requirements.

The detachable nipple, which attaches to the first side of the protective guard, is made from a soft material like medical-grade silicone or latex and is designed to allow liquid flow when the infant applies suction. This nipple simulates the feel of natural feeding and offers comfort to the infant, encouraging a calming sucking action. The nipple can be swapped with other sizes or shapes based on the infant's preferences or developmental needs, allowing for a range of options that accommodate different ages and comfort requirements.

On the second side of the protective guard, a detachable food storage chamber is secured, forming an internal cavity that can hold liquid food, formula, or medication. The food storage chamber includes at least one fill port, which allows caregivers to introduce liquid into the chamber either through a feeding tube or by direct filling with a syringe or dropper. This modular design makes the storage chamber adaptable, as different chamber sizes can be attached to accommodate varying volumes of liquid based on the infant's feeding needs.

The feeding tube connects a liquid food pouch to the fill port of the food storage chamber, providing a direct conduit for transferring the liquid from the pouch to the chamber. The feeding tube is designed to be flexible and made from medical-grade materials, allowing it to bend without kinking, which maintains a continuous liquid flow. At the first end of the feeding tube, a connector is positioned to establish a secure, sterile, and leak-proof connection with the liquid food pouch, so that the liquid remains uncontaminated throughout the feeding process. The connector may feature different attachment mechanisms, such as a threaded or snap-fit connection, to suit various types of pouches.

An opening in the protective guard between the food storage chamber and the nipple enables the flow of liquid from the chamber to the nipple. This pathway allows the liquid to reach the infant's mouth when they apply suction on the nipple, making feeding natural and efficient. Positioned within this opening is a second flow control valve, configured to manage the release of liquid from the storage chamber to the nipple. This valve responds to the infant's sucking pressure, releasing liquid in a controlled manner to match the infant's feeding pace, thus reducing the risk of overfeeding or choking.

To further regulate the flow rate from the liquid food pouch to the storage chamber, a flow controller is integrated into the feeding tube. This flow controller may include a dial or clamp that allows caregivers to adjust the liquid flow rate, providing flexibility to accommodate the infant's specific needs. For example, caregivers may select a slower flow for younger infants or a faster rate for older infants who can handle a more substantial intake. Additionally, a drip chamber can be included within the flow controller to allow visual monitoring of the liquid flow, enabling caregivers to monitor that the flow is consistent and appropriately paced.

A first flow control valve, positioned within the fill port of the food storage chamber, serves as a one-way valve. This valve permits liquid to enter the chamber from the feeding tube but prevents backflow, maintaining the cleanliness of the liquid within the storage chamber and preventing contamination. The one-way functionality of this valve is particularly advantageous for feeding scenarios involving medicine, as it allows the medicine to be delivered in precise doses without mixing back into the feeding line.

To protect the pacifier's components when not in use, the system includes two protective caps. A first protective cap attaches to the first side of the protective guard, covering the nipple to keep it hygienic between uses. This cap is especially useful for travel or storage, as it prevents dirt, germs, or other contaminants from reaching the nipple. A second protective cap attaches to the second side of the protective guard, covering the food storage chamber. This cap maintains the cleanliness of the chamber and protects the liquid contents from contamination during non-use, making the pacifier suitable for both home and outdoor settings.

The modular pacifier system also includes interchangeable components, allowing customization based on the infant's specific feeding needs or age. Different sizes and shapes of nipples can be attached to match the infant's developmental stage or comfort preferences. Additionally, food storage chambers of varying capacities can be swapped, providing flexibility in the amount of liquid that can be stored and delivered. Feeding tubes and protective caps are also interchangeable, accommodating different liquid pouches and offering convenience for caregivers who may need to adjust the pacifier setup based on the feeding scenario.

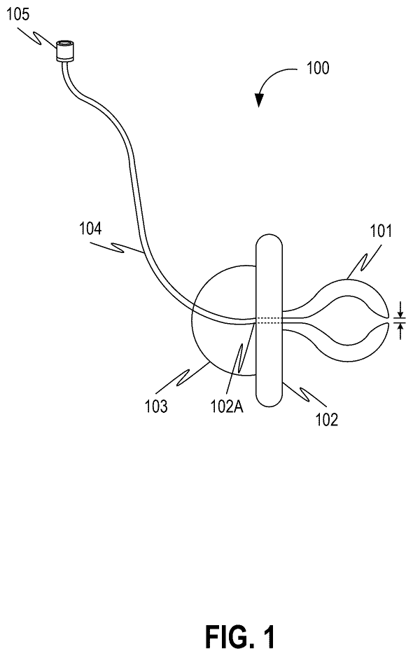

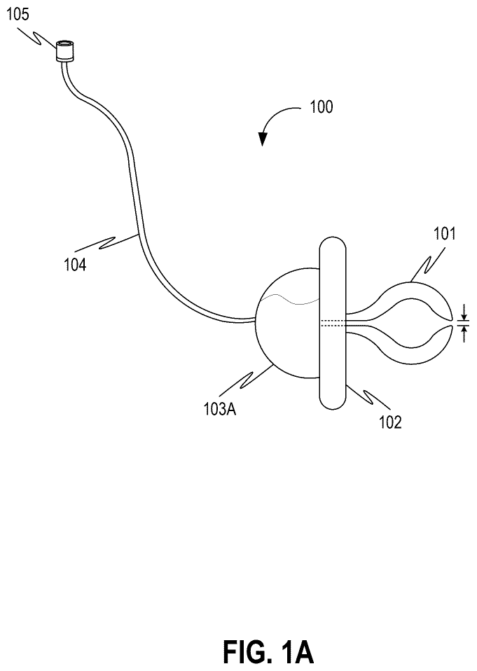

Referring to FIG. 1, it illustrates a schematic diagram of a baby pacifier 100 comprising a feeding line 104, according to some embodiments of the present invention. The pacifier 100 integrates a traditional pacifier with a specialized feeding line mechanism 104 constructed to deliver liquid food, medicine, or water to an infant in a controlled, hygienic, and efficient manner.

The pacifier 100 includes a nipple 101, which is constructed from a soft, flexible material such as silicone or latex. The nipple 101 may be constructed to mimic the feel and function of a mother's breast, providing a soothing and natural experience for the infant. The nipple 101 is attached to a protective guard 102, which serves as a safety feature to prevent the pacifier from being fully inserted into the infant's mouth. The protective guard 102 may typically be made of a rigid, durable material and is shaped to allow the pacifier to remain comfortably and securely positioned during use. In some embodiments, the protective guard 102 may feature an ergonomic design to further enhance comfort and prevent accidental dislodgement.

Attached to the protective guard 102 is a convenient ring 103, which allows for easy handling and attachment to pacifier clips or holders. The ring 103 may also be useful for caregivers or children to grip and manipulate the pacifier during feeding or cleaning. In some embodiments, the ring 103 may include a textured or slip-resistant surface to improve grip.

Extending from the protective guard 102 is a feeding line 104, which acts as a conduit for the liquid being administered. The feeding line 104 may be directly connected to an opening 102A in the protective guard 102, allowing for a secure and seamless integration with the pacifier 100. The feeding line 104 may be made from medical-grade silicone or a similar material that is flexible, durable, and safe for infant use. The feeding line 104 may be connected at one end to the nipple 101 (e.g., through the opening 102A in the protective guard 102), allowing the liquid to flow directly into the infant's mouth when they suck on the pacifier 100. In some embodiments, the feeding line 104 may have anti-kink properties to prevent blockages and provide smooth liquid flow.

At the other end of the feeding line 104 is a connector 105 (which may be a piercing connector, Luer lock, or similar mechanism). The connector 105 may be constructed to securely attach to a liquid container (not shown in this figure), similar to the connectors used in IV glucose setups. The connector 105 may comprise a sharp tip that allows it to penetrate the seal of the liquid container, allowing a sterile and leak-proof connection. The design of the piercing connector 105 allows that the liquid from the container can flow smoothly into the feeding line 104 and subsequently to the nipple 101. In some embodiments, the connector 105 may be fitted with a cap to protect the sharp tip when not in use, enhancing safety and preventing contamination.

The pacifier 100 may also include a flow controller (not shown in this figure) integrated into the feeding line 104. The flow controller may be constructed to regulate the flow of liquid from the container through the feeding line 104, allowing that the infant receives the appropriate amount of liquid at a comfortable pace. This controller can be similar to those used in IV systems, providing precise adjustable control over the liquid flow rate. In some embodiments, the flow controller may include a dial or clamp mechanism that can be set to different flow rates based on the infant's needs or the type of liquid being administered. For example, a slower flow rate may be preferable for thicker liquids like milk or medication.

In some embodiments, the feeding line 104 may incorporate a drip chamber (not shown in FIG. 1) to allow caregivers to visually monitor the liquid flow. The drip chamber provides real-time feedback, helping users to confirm that the liquid is flowing properly and alerting them of any blockages or irregularities. Another possible enhancement is the inclusion of a protective cap over the nipple 101, which can be used when the pacifier 100 is not in use to maintain hygiene and prevent contamination.

The pacifier system 100 may be used to deliver a range of liquids, including milk, juice, water, medicine, baby formula, and electrolyte solutions. This versatility allows caregivers to meet various feeding and hydration needs. For example, if a child needs to take medication but resists traditional administration methods, this pacifier system provides a more comforting and familiar approach. Additionally, in scenarios where precise dosing is required, such as with certain medications, the flow controller allows for careful measurement and delivery of each dose.

Referring now to FIG. 1A, the figure illustrates an alternative schematic configuration of a baby pacifier 100, where a feeding line 104 is connected to a liquid storage chamber 103A (instead of the opening 102A in the protective guard 102 as shown in FIG. 1). In such embodiments, the traditional ring (previously referenced as 103 in FIG. 1) has been replaced by the liquid storage chamber 103A, which serves as an integral component for holding liquid food, medicine, or hydration solutions such as water or electrolytes. The feeding line 104 itself may be removably attachable to the liquid storage chamber 103A. This design variation allows the pacifier 100 to function as a more mobile unit, meaning the baby or young child can move around freely while using it without needing to be tethered to an external container. The liquid storage chamber 103A is designed to be compact yet capable of holding a sufficient amount of liquid, providing caregivers with the flexibility to offer feeding solutions without constantly refilling or holding additional equipment. This mobile capability may especially be beneficial during outings or for active infants who may not sit still during feedings.

The liquid storage chamber 103A in FIG. 1A is constructed to facilitate the smooth flow of liquid from the liquid storage chamber 103A directly to the nipple 101 through an opening (e.g., 102A in FIG. 1) in the protective guard 102. This setup creates a direct path for liquid to pass from the chamber 103A, through the feeding line 104, and ultimately into the nipple 101, where it can be comfortably accessed by the infant. The protective guard 102 acts as both a safety feature, preventing the pacifier 100 from entering the child's mouth too deeply, and a functional element, connecting the nipple 101 to the liquid storage chamber 103A and providing stability during feeding. This internal routing minimizes leaks or spills, as the liquid is directed in a controlled manner from the liquid storage chamber 103A to the nipple 101, making the feeding experience cleaner and more reliable.

One of the unique features of this design is the ability to fill the liquid storage chamber 103A with various liquids depending on the infant's needs. For example, caregivers can fill the chamber with milk, juice, baby formula, water, or even specialized electrolyte solutions, depending on the hydration and nutritional needs of the child. The filling process can be accomplished in multiple ways. In some embodiments, the feeding line 104 itself may serve as an entry point for filling the liquid storage chamber 103A, allowing caregivers to use a syringe, food container, or other liquid delivery system to inject the desired liquid directly into the liquid storage chamber 103A. This method is particularly useful for measured dosages, such as when administering medication or when exact quantities of liquid are needed for dietary management.

In other embodiments, the liquid storage chamber 103A may feature a separate inlet or fill port, which can be sealed after filling to prevent leaks. This inlet may be a small, closable valve or a self-sealing membrane that can be pierced by a syringe needle, allowing caregivers to inject liquids into the liquid storage chamber 103A without removing any parts of the pacifier system. This fill port design may be particularly advantageous in situations where quick refills are required or when caregivers need to switch between different liquids throughout the day. Additionally, the liquid storage chamber 103A may be constructed from a transparent or translucent material, allowing caregivers to easily monitor the liquid level and assess whether a refill is needed.

The nipple 101 in this embodiment may be designed in various sizes, accommodating different ages and sucking capabilities of children. Infants and toddlers have different oral structures and sucking reflex strengths, which is why offering various nipple sizes and shapes can improve the feeding experience. For example, newborns may benefit from a smaller nipple that mimics the size and softness of a mother's nipple, while older infants may require a larger, sturdier nipple to support their stronger sucking reflex. Furthermore, the nipple 101 may be designed to be removably attachable to the protective guard 102, allowing caregivers to switch out different nipple types based on the child's needs or to replace the nipple 101 when it becomes worn or damaged (similar to baby milk bottles).

In terms of materials, the liquid storage chamber 103A may be constructed from infant-safe materials, such as BPA-free plastic or medical-grade silicone, to prevent any harmful substances from leaching into the liquid. The choice of material helps the pacifier to remain hygienic and easy to clean, as silicone and BPA-free plastics are resistant to bacterial growth and can withstand repeated sterilization. Additionally, the protective guard 102 may be made from a similarly durable material, supporting the overall structural integrity of the pacifier 100 and withstanding the pressure exerted during the sucking process.

The pacifier 100 as depicted in FIG. 1A provides a practical solution for feeding infants on the go, particularly useful in settings where access to traditional feeding tools is limited. Since the liquid storage chamber 103A is integrated into the pacifier 100 itself, caregivers can prepare the pacifier 100 in advance by filling the liquid storage chamber 103A with the desired liquid before leaving home, making it convenient for travel, outdoor activities, or busy environments.

Moreover, the feeding line 104, which is connected to an opening (102A) in the protective guard 102, acts as a controlled pathway for the liquid to flow from the liquid storage chamber 103A to the nipple 101. In some embodiments, the feeding line 104 may incorporate an internal flow controller or valve that allows caregivers to adjust the rate at which the liquid flows. This is particularly useful when administering liquids of varying viscosity, as thicker liquids like milk or certain medications require a slower flow rate to prevent the infant from choking. Alternatively, water or diluted juice may be dispensed at a slightly faster rate, depending on the infant's comfort and hydration needs.

In some embodiments, the liquid storage chamber 103A may include measurement markings along its exterior, allowing caregivers to precisely gauge the amount of liquid being administered. This feature may be particularly beneficial for parents who need to track their infant's fluid intake for health monitoring, as it provides a clear visual guide for exact quantities. For example, if a child needs to consume a specific amount of milk or water daily, caregivers can use these markings to administer incremental doses throughout the day, filling the chamber only as much as required for each feeding session.

Furthermore, to enhance the functionality of the liquid storage chamber 103A, some embodiments may incorporate insulation layers within the chamber's walls, helping maintain the temperature of the liquid for an extended period. This may be especially useful for infants who prefer warm milk, as the insulated chamber would retain heat longer than a standard container. For on-the-go use, the liquid storage chamber 103A may be pre-filled with warm liquid food, milk or water, which would remain at an ideal feeding temperature during outdoor activities or outings.

The liquid storage chamber 103A may also be detachable from the pacifier system, allowing for easier cleaning and maintenance. Detachability enables caregivers to thoroughly wash and sterilize the liquid storage chamber 103A after each use, providing a high standard of hygiene. In addition, this detachable design allows caregivers to swap out storage chambers (may be of different sizes) if they prefer to have multiple chambers pre-filled with different liquids, thus enabling quick changes without having to clean and refill the same chamber repeatedly.

In terms of aesthetic design, the liquid storage chamber 103A may be offered in various colors and designs, appealing to infants, and making the pacifier system more engaging. Bright colors, patterns, or even animal-themed designs can capture the infant's attention and make the pacifier system visually appealing. Additionally, the liquid storage chamber 103A may incorporate textured surfaces that provide sensory stimulation for the infant, contributing to an overall comforting experience.

This design variation also allows for easy integration of supplemental feeding practices, where caregivers can add vitamins, supplements, or minor quantities of medications directly into the liquid storage chamber 103A, especially in diluted form. This feature may be helpful for parents who need to administer daily supplements, as the pacifier system combines the feeding process with the delivery of these additives in a way that feels natural to the infant.

Furthermore, advanced versions of the pacifier system may integrate smart technology, where the liquid storage chamber 103A includes a sensor that monitors the temperature and flow rate of the liquid. This data may be relayed to a caregiver's smartphone app, providing real-time feedback on the feeding process. For example, the app may notify the caregiver if the liquid is too cold or if the flow rate needs adjustment, thereby enhancing the control and safety of the feeding experience. Additionally, caregivers may receive reminders to refill the liquid storage chamber 103A or alerts when the liquid level is low, making the pacifier system a convenient, tech-enhanced feeding solution.

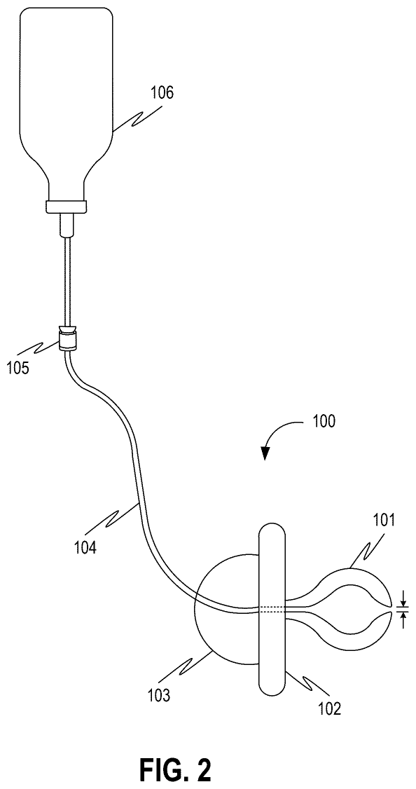

Referring now to FIG. 2, it illustrates an exemplary baby pacifier 100 connected to a liquid container 106 in some embodiments of the present invention. FIG. 2 provides a detailed view of the system's components and their interconnections, demonstrating how the pacifier system facilitates the feeding of liquid food, medicine, or water to an infant or child.

The pacifier 100 comprises several key components: a nipple 101, a protective guard 102, a ring 103, a feeding line 104, a connector 105, and a liquid container 106. These components work cohesively to form a reliable feeding apparatus that is simple for caregivers to operate while providing a comfortable feeding experience for the infant.

The nipple 101 may be made from a soft, flexible material such as medical-grade silicone or latex. This material selection allows the nipple 101 to mimic the feel and function of a mother's breast, providing comfort and a natural feeding experience for the infant. The nipple is the part that the baby interacts with, as it is designed to facilitate sucking, allowing the infant to draw liquid from the system in a familiar and soothing manner. In some embodiments, the nipple 101 may feature additional textures to enhance grip and comfort for infants who are transitioning from breastfeeding to pacifier feeding.

The protective guard 102 is attached to the nipple 101 and serves as a safety feature to prevent the pacifier 100 from being fully inserted into the infant's mouth. The protective guard 102 may typically be made of a rigid, durable material providing structural support and preventing choking hazards. The protective guard 102 may be shaped to provide a comfortable and secure positioning of the pacifier during use.

The ring 103 is connected to the protective guard 102, providing a convenient handle for caregivers and a point of attachment for pacifier clips or holders. The ring 103 also enables easy manipulation of the pacifier 100 during feeding and cleaning. In certain embodiments, the ring 103 may be detachable (removably attachable), allowing caregivers to swap it with other accessories or attachments as needed. This flexibility allows the pacifier system to be customized for various scenarios, such as securing it with clips or attaching it to portable cases.

The feeding line 104 is a flexible tube that connects the pacifier 100 to the liquid container 106. It may be made from medical-grade silicone or a similar material that provides both flexibility and durability. The feeding line 104 may serve as a conduit for the liquid, allowing it to flow from the liquid container 106 to the nipple 101 when the infant sucks on the pacifier 100. In some embodiments, the feeding line 104 may comprise an anti-kink design, which prevents blockages and maintains consistent liquid flow. This characteristic may be advantageous for active infants, as it keeps the feeding uninterrupted even if the feeding line 104 is bent or twisted.

At the proximal end of the feeding line 104, there is a connector 105. The connector 105 may comprise a sharp, sterile tip or a Luer lock mechanism, similar to those used in IV glucose setups, designed to penetrate the seal of the liquid container 106 securely. The piercing connector 105 provides a secure and sterile connection, preventing leaks and contamination while allowing the liquid to flow into the feeding line 104. In some embodiments, the connector 105 may include multiple and/or various types of connection mechanisms, such as, one or more of: snap-fit, friction-fit, or threaded connectors, to accommodate different types of liquid containers (106) and provide flexibility in use. For example, in some setups, a threaded connector may enhance stability during long feeding sessions.

The liquid container 106 holds the liquid food, medicine, baby formula, juice, honey, or water that is to be fed to the infant. The liquid container 106 can be made from BPA-free plastic or medical-grade silicone, or similar safe, non-toxic materials, making it safe for infant use. The container 106 may be constructed to be easily replaceable and can hold various types of liquids, providing versatility in feeding options. In certain embodiments, the liquid container 106 may take the form of pouches, such as disposable pouches made of food-grade plastic, which are easy to replace and ideal for travel or single-use scenarios. Reusable silicone pouches may also be used for caregivers who prefer an eco-friendly option. These pouches offer flexibility in storage and are lightweight, making them convenient for caregivers on the go.

In some embodiments, the feeding line 104 connects the liquid container 106 to the pacifier system 100. The liquid flows from the liquid container 106 through the feeding line 104, and is then directed into the nipple 101 through an integrated flow mechanism, which helps maintain a steady flow when the infant sucks on the pacifier 100. This design allows caregivers to deliver nutrients, hydration, or medication in a manner that is comfortable and natural for the infant. The flow mechanism within the feeding line 104 or the liquid container 106 may include a valve or restrictor that controls the liquid flow rate, accommodating different types of liquids which may have disparate viscosities, such as thicker milk or thinner electrolyte solutions.

The pacifier system may also incorporate additional features, such as a flow controller (not shown in this figure) to regulate the rate of liquid flow from the liquid container 106 to the nipple 101. The flow controller can be similar to those found in IV systems, providing adjustable control over the liquid flow rate to deliver the desired amount of liquid at a comfortable pace for the infant. In some embodiments, the flow controller may feature a dial or slider, allowing caregivers to fine-tune the flow based on the infant's age, preference, or type of liquid. For example, a slower flow setting may be used for infants transitioning to solid foods, while a faster setting may be more appropriate for older infants who drink water or juice.

In some embodiments, the connector 105 may be configured in the form of a bottle cap with threading, allowing it to attach securely to the liquid container 106. This bottle cap-style connector 105 features threads on its inner surface, which correspond to matching threads on the mouth of the liquid container 106. When assembling the system, the caregiver can rotate the connector 105 onto the liquid container 106, similar to how a conventional bottle cap is attached or removed from a bottle. The threaded mechanism provides a stable and leak-proof seal between the connector 105 and the liquid container 106, preventing any accidental spillage or contamination during feeding.

The threaded connector design offers both simplicity and reliability, as it allows for quick and secure attachment or removal. In scenarios where caregivers need to frequently replace the liquid container 106, the bottle cap-style connector 105 makes it easy to swap out containers without the need for complex tools or connectors. The twisting motion required to secure or detach the connector 105 is intuitive and convenient, enabling caregivers to prepare the pacifier system efficiently, even with limited time.

At the center of the connector 105 (threaded cap), a port may be provided where the feeding line 104 is integrated. This central positioning of the feeding line 104 allows liquid to flow directly from the liquid container 106 into the feeding line 104, creating a direct pathway to the nipple 101. When the infant sucks on the nipple 101, the liquid is drawn smoothly from the liquid container 106, through the feeding line 104, and into the mouth, providing a consistent and controlled feeding experience.

In some embodiments, the bottle cap-style connector 105 may be designed to include additional sealing features, such as a silicone gasket or O-ring around the threads, which further enhances the leak-proof capabilities of the connection. This gasket compresses slightly when the connector 105 is twisted onto the liquid container 106, forming an airtight seal that prevents leaks even if the liquid container 106 is turned or jostled. This design is particularly useful for active infants or for caregivers who wish to carry the assembled pacifier system in a diaper bag or while on the go.

Moreover, the bottle cap-style connector 105 may be compatible with a variety of liquid container shapes and sizes, provided they share the same threading standard. This compatibility allows caregivers to use multiple containers interchangeably, making it easier to prepare different liquids, such as milk, juice, or water, in advance. For example, one container may hold water for hydration, while another holds milk for nutritional feeding. The caregiver can quickly attach the pacifier system to the appropriate container as needed, offering a versatile solution for different feeding requirements.

In some embodiments, the feeding line 104 may also be configured to be removably attachable to the pacifier 100, allowing caregivers to detach and reattach the feeding line 104 as needed. This feature provides flexibility and convenience, especially in scenarios where different feeding lines (104) may be required based on the size or type of liquid container (106) being used. The removable design allows the feeding line 104 to be easily replaced, cleaned, or interchanged with other feeding lines, enhancing the overall hygiene and usability of the pacifier system.

Additionally, different feeding lines 104 may be equipped with bottle cap-style connectors 105 of various sizes, designed to fit on different sizes of liquid container mouths. This variation in connector sizes allows the pacifier system to be used with a wide range of liquid containers 106, each potentially having a different mouth diameter or threading pattern. For example, one feeding line 104 may feature a smaller bottle cap-style connector 105 that fits securely on the mouth of a compact, travel-sized liquid container 106. Another feeding line 104 may have a larger connector 105 to accommodate larger liquid containers 106 that hold a greater volume of liquid, such as full-size bottles.

The bottle cap-style connector 105 on each feeding line 104 may include threading that matches the specific container size it is designed to fit. When assembling the system, the caregiver can select the feeding line 104 with the appropriate connector size and twist it onto the liquid container 106 in a manner similar to attaching a bottle cap. This straightforward twisting mechanism allows for a secure, leak-proof connection between the feeding line 104 and the liquid container 106, facilitating that the liquid is safely contained during feeding.

This modular design offers significant versatility for caregivers, as they can choose the ideal feeding line and container combination for various feeding scenarios. For example, during a short outing, a caregiver may opt for a smaller liquid container with a corresponding small-sized feeding line. For longer trips or situations where more liquid is required, they may attach a larger feeding line with a matching connector to a full-size container, providing sufficient liquid for extended feeding sessions without frequent refills.

The removability of the feeding line 104 also aids in cleaning and sterilization. Since feeding lines 104 can be detached and swapped out, caregivers can easily clean each component individually, providing a high level of hygiene. Additionally, the option to use different feeding lines allows caregivers to dedicate specific lines to particular types of liquids, such as one line for milk and another for water or juice, reducing the risk of cross-contamination and preserving the taste and quality of each liquid.

In some embodiments, each feeding line 104 may include color-coded or labeled connectors 105 to help caregivers quickly identify which feeding line is compatible with specific container sizes. This labeling system may simplify the selection process, allowing caregivers to efficiently prepare the pacifier system without trial and error. For example, a blue connector may indicate compatibility with small-sized containers, while a green connector signifies compatibility with larger containers.

In some embodiments, the ring 103 may be replaced with a liquid storage chamber 103A, as illustrated in FIG. 1A. This liquid storage chamber 103A serves as an integrated reservoir within the pacifier system, capable of holding liquid food, medicine, or hydration solutions such as water or electrolytes. By incorporating the liquid storage chamber 103A directly into the pacifier 100, this design enables caregivers to provide a self-contained feeding solution, eliminating the need for an external liquid container. In other embodiments, the liquid storage chamber 103A may connect to the feeding line 104, allowing liquid to flow from the liquid container 106, to the liquid storage chamber 103A, through the protective guard 102 and into the nipple 101 when the infant sucks on the pacifier 100. The liquid storage chamber 103A may be designed to be easily refillable through the feeding line 104 or a separate inlet, offering caregivers flexibility in administering various liquids to meet the infant's needs.

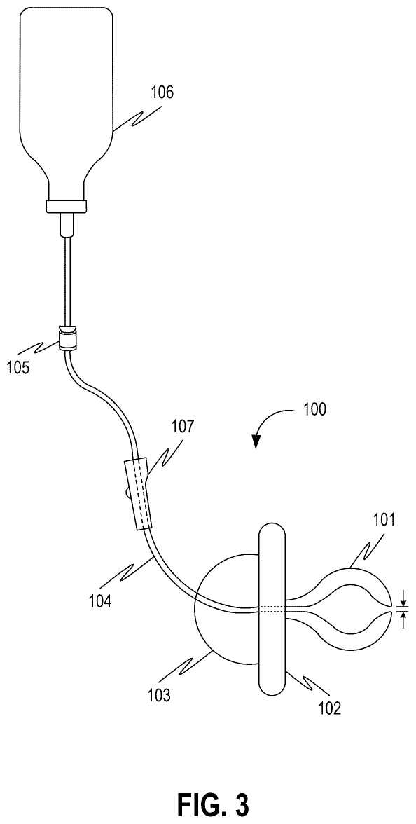

Referring now to FIG. 3, it illustrates a schematic diagram of an exemplary baby pacifier 100 comprising a flow controller 107 in the feeding line 104. FIG. 3 provides a detailed view of how the pacifier system integrates various components to provide the controlled delivery of liquid food, medicine, or water to an infant. This embodiment facilitates that caregivers have enhanced control over the flow rate, adapting the feeding experience to the specific needs of the infant.

The nipple 101 may be constructed from a soft, flexible material such as medical-grade silicone or latex, constructed to mimic the feel and function of a mother's breast. This design provides comfort and a natural feeding experience for the infant, encouraging them to suck on the pacifier 100 to draw the liquid through the system. In some embodiments, the nipple 101 may be available in various shapes and textures to suit different developmental stages and preferences of infants, offering flexibility for caregivers in selecting the most suitable option.

Attached to the nipple 101 is a protective guard 102, which serves as a safety feature to prevent the pacifier 100 from being fully inserted into the infant's mouth. The protective guard 102 may typically be made of a rigid, durable material, providing structural integrity, and allowing the pacifier 100 to remain securely and comfortably positioned during use. In certain embodiments, the protective guard 102 may include ventilation holes to enhance airflow around the infant's mouth, reducing skin irritation and enhancing comfort during prolonged use.

The ring 103 is connected to the protective guard 102, providing a convenient handle for caregivers to hold and manipulate the pacifier 100. The ring 103 may also allow for easy attachment to pacifier clips or holders, so that the pacifier 100 can be kept clean and accessible when not in use. In some versions, the ring 103 may be detachable or replaced with accessories such as a storage chamber (103A, as seen in FIG. 1A) to enhance the functionality of the pacifier system.

The feeding line 104, made from flexible medical-grade silicone or similar materials, connects the pacifier 100 to the liquid container 106. This feeding line 104 serves as a conduit for the liquid, allowing it to flow smoothly from the liquid container 106 to the nipple 101 when the infant sucks on the pacifier 100. The flexibility of the feeding line 104 allows caregivers to position the liquid container 106 comfortably, whether the pacifier system is used at home or on the go. In certain embodiments, the feeding line 104 may be designed with an anti-kink feature, preventing blockages or disruptions in liquid flow even when the line is bent or twisted.

At the proximal end of the feeding line 104, there is a connector 105. The connector 105 may comprise a sharp tip or a Luer lock mechanism, constructed to penetrate the seal of the liquid container 106, similar to connectors used in IV glucose setups, or a bottle cap-style connector designed to securely attach to the mouth of the liquid container 106. The connector 105 may incorporate a bottle cap-style design with threads, allowing the caregiver to attach it securely to a variety of container sizes, enhancing compatibility and convenience. The connector 105 provides a secure, sterile, and a leak-proof connection, allowing the liquid to flow from the liquid container 106 into the feeding line 104.

The liquid container 106 holds the liquid food, juice, medicine, or water to be fed to the infant. It can be made from BPA-free plastic or medical-grade silicone, or other non-toxic materials, providing safety for infant use. The liquid container 106 may be constructed to be easily replaceable and can hold various types of liquids, providing versatility in feeding options. For example, disposable pouches may be used as the liquid container 106 for convenient, single-use applications, while reusable containers offer an eco-friendly alternative.

The flow controller 107 may be integrated into the feeding line 104. The flow controller 107 may be constructed to regulate the flow of liquid from the liquid container 106 through the feeding line 104 and into the nipple 101. The flow controller 107 may comprise a clamp or dial mechanism, similar to those used in IV systems, allowing caregivers to precisely adjust the flow rate based on the infant's needs. For example, a slower flow rate may be set when administering thicker liquids like milk, while a faster rate may be used for thinner liquids such as water or electrolyte solutions. By adjusting the flow controller, caregivers can tailor the feeding experience to reduce the risk of choking or overfeeding, so that the infant receives an appropriate amount of liquid comfortably.

In some embodiments, the flow controller 107 may also include a drip chamber, a transparent section of the feeding line that allows caregivers to visually monitor the liquid flow. The drip chamber provides real-time feedback on the flow rate, allowing that the liquid is being administered correctly and helping to detect any blockages or irregularities in the flow. This feature is particularly useful when administering medication, as it enables precise control and verification of the dosage being delivered to the infant.

In operation, the liquid container 106 is filled with the desired liquid, such as milk, juice, water, or medication. The connector 105 is used to attach the feeding line 104 to the container 106, creating a secure and sterile connection. The flow controller 107 is adjusted to the appropriate setting, regulating the flow rate of the liquid. When the infant sucks on the nipple 101, the liquid flows from the liquid container 106 through the feeding line 104 and into the nipple 101, allowing the infant to consume the liquid comfortably and safely.

In some alternative embodiments, the flow controller 107 may comprise a digital interface or electronic flow sensor that connects to a mobile app. This app may provide caregivers with real-time data on the liquid flow rate, the volume consumed, and reminders for refilling the liquid container 106. Such embodiments may allow for precise tracking of the infant's hydration or nutritional intake, making it particularly useful for caregivers managing specific feeding schedules or medication dosages.

The pacifier system shown in FIG. 3 is ideal for situations where careful monitoring of liquid intake is needed, such as when feeding infants with specific dietary requirements or administering prescribed medications. For example, a caregiver can use the flow controller 107 to maintain a consistent flow rate for electrolyte solutions, so that the infant stays hydrated without overconsumption. Similarly, when administering liquid medication, the drip chamber and flow controller provide a controlled and verified delivery, making the process safer and more reliable.

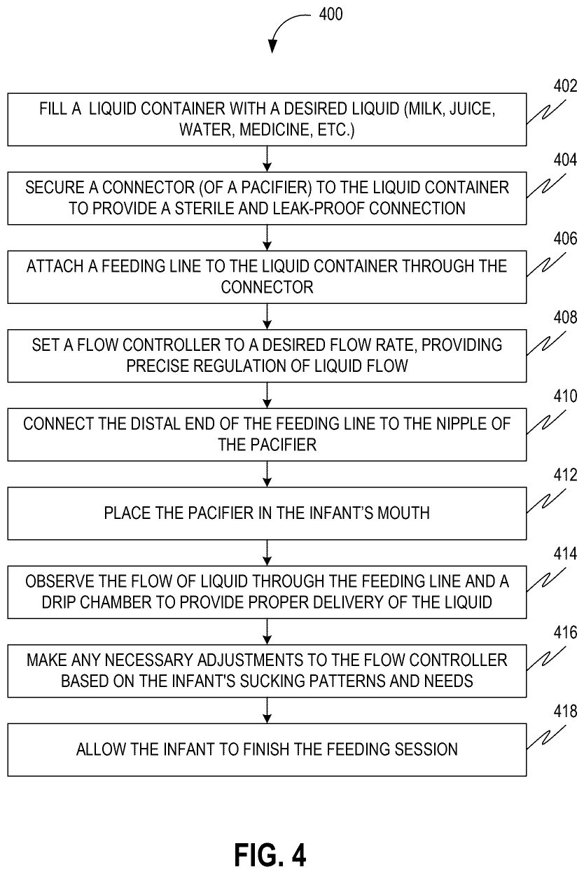

Referring now to FIG. 4, it illustrates exemplary method steps that can be performed according to the present invention. The flow chart 400 details the process of using the baby pacifier to feed an infant with liquid food, medicine, or water in accordance with some embodiments of the present invention. This systematic approach offers caregivers a straightforward and effective method to deliver liquids to infants in a controlled and safe manner.

At step 402, the process begins with filling a liquid container with a desired liquid. This may be milk, juice, baby formula, water, medicine, or any other suitable liquid. The container may be made from a material that is safe for infants, such as BPA-free plastic or medical-grade silicone, so that the liquid remains safe and uncontaminated. In some embodiments, caregivers may also use pre-filled disposable pouches as the liquid container, providing convenience and minimizing the need for cleaning after each use.

At step 404, the next step involves securing a connector, which is part of the pacifier system, to the liquid container. The connector may be constructed to provide a sterile and leak-proof connection, so that the liquid does not spill and remains uncontaminated. The connector may typically include a sharp tip, a Luer lock, or bottle cap-style threading connector that can securely attach to the container's opening. This secure connection is especially beneficial in scenarios where the pacifier system is used on the go, as it prevents leaks and maintains hygiene.

At step 406, a feeding line is attached to the liquid container through the connector. The feeding line is a flexible tube made from medical-grade silicone or similar, safe, flexible materials, specifically designed to transport the liquid from the container to the pacifier without compromising on hygiene or flexibility. In certain embodiments, the feeding line may include anti-kink properties to prevent any disruption in liquid flow, so that the feeding process remains smooth.

At step 408, a flow controller is set to a desired flow rate. The flow controller may be an integral component that allows caregivers to regulate the liquid flow precisely, allowing that the infant receives the appropriate amount of liquid at a comfortable pace. This step may involve adjusting a clamp, dial, slider, or other mechanisms on the flow controller to customize the flow rate according to the infant's age, feeding speed, and the type of liquid being administered. For example, a slower flow setting may be used for thicker liquids like milk or pureed foods, while a faster setting may be preferable for water or electrolyte solutions.

At step 410, a distal end of the feeding line is connected to the nipple of the pacifier. This connection allows the liquid to flow directly into the nipple when the infant sucks on the pacifier, facilitating a natural and uninterrupted feeding experience. In some embodiments, the nipple may be removably attachable and available in various shapes and sizes to accommodate different ages and preferences of infants, enhancing comfort and facilitating that the system can be tailored to individual needs.

At step 412, the pacifier is placed in the infant's mouth. The nipple is constructed to mimic the feel and function of a mother's breast, providing comfort, and encouraging the infant to suck, which draws the liquid from the container through the feeding line, allowing the infant to consume the liquid naturally. The pacifier design may especially be beneficial for infants who may resist traditional feeding bottles, as it offers a familiar and soothing feeding method.

At step 414, the caregiver observes the flow of liquid through the feeding line and a drip chamber. The drip chamber may be a transparent section of the feeding line that allows for visual monitoring of the liquid flow, for providing proper delivery. This step provides verification that the liquid is being administered correctly and identifying any potential issues such as blockages or irregular flow rates. The drip chamber may particularly be useful when administering medication, as it helps in confirming that the dosage is delivered accurately and consistently.

At step 416, any adjustments to the flow controller may be made based on the infant's sucking patterns and needs. This step allows that the liquid flow remains consistent and appropriate for the infant's consumption rate, providing a comfortable and safe feeding experience. If the infant shows signs of discomfort or requires a different flow rate, the caregiver can quickly modify the setting to adjust the liquid delivery speed, making the feeding experience more comfortable and tailored to the infant's consumption rate. This adaptive control is especially valuable in situations where the infant has specific feeding needs, such as a slower pace for younger infants or a faster flow for older, more experienced feeders.

At step 418, the process concludes by allowing the infant to finish the feeding session. The caregiver confirms that the infant receives the entire or desired amount of liquid, whether it be food, medicine, or water, before removing the pacifier and disassembling the system for cleaning and storage. In some embodiments, one or more of: the feeding line, connector, ring, storage chamber, protective guard, nipple, and flow controller may be detachable, allowing for thorough cleaning and sterilization of each part.

Each of these steps outlines a clear and systematic approach to using the baby pacifier system, helping caregivers to feed infants efficiently and safely. The method combines the soothing benefits of a traditional pacifier with an effective liquid delivery mechanism, addressing common challenges in feeding and medicating infants.

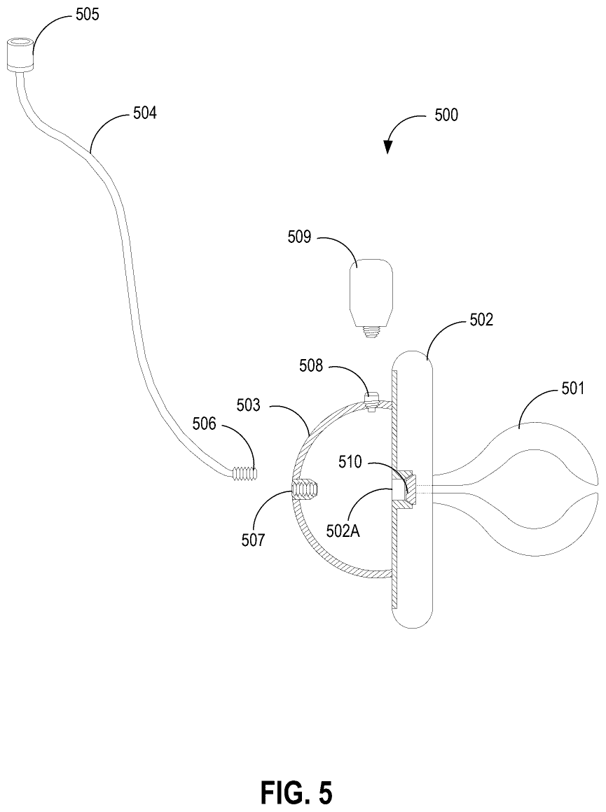

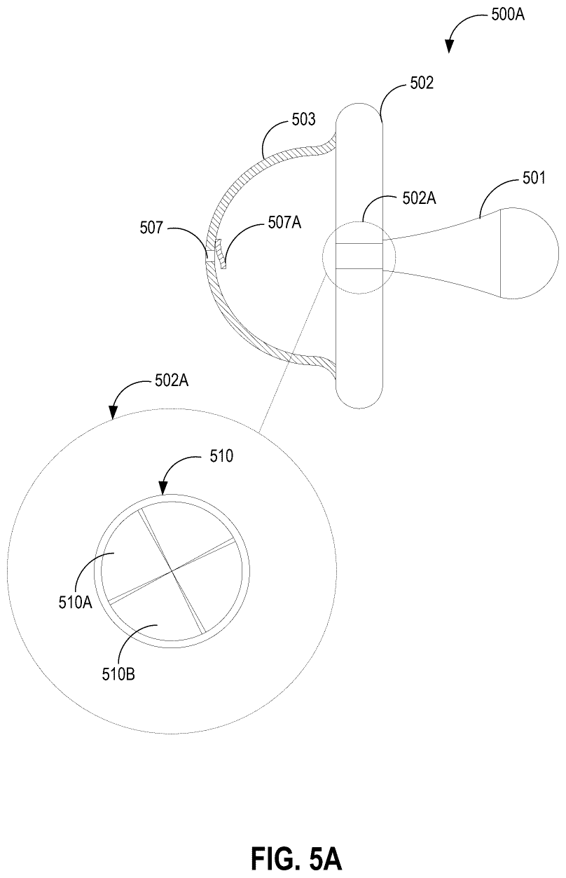

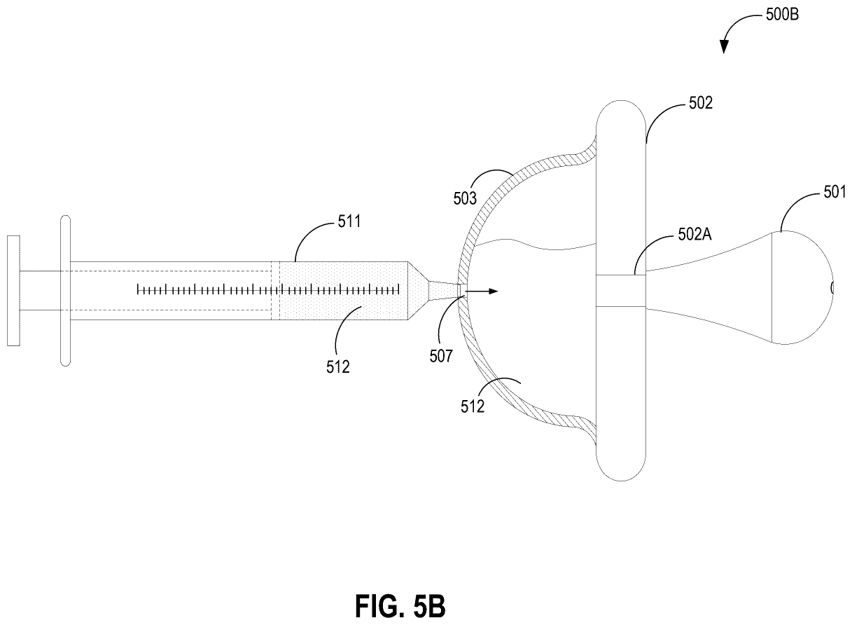

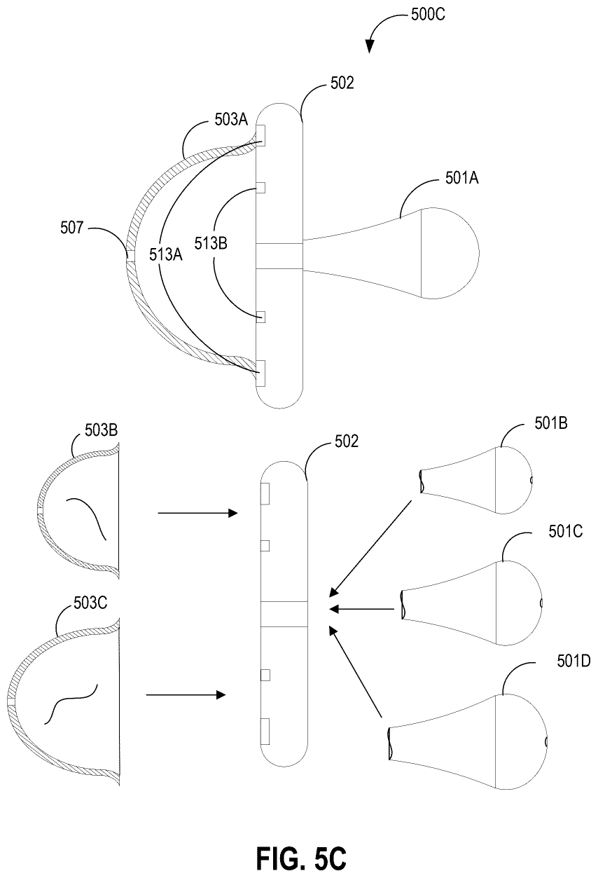

Referring now to FIG. 5, the illustration depicts an exemplary baby pacifier 500, which includes a food storage chamber 503 with one or more inlets or fill ports, according to some embodiments of the present invention. In this configuration, the food storage chamber 503 is designed to hold liquid food, milk, baby formula, medicine, or water, facilitating convenient feeding for infants or young children. The pacifier system 500 demonstrates an innovative approach to integrating a storage chamber directly within the pacifier 500, which can be filled through specific inlet ports, allowing flexibility in how caregivers administer liquids.

The food storage chamber 503 in FIG. 5 is shown with two exemplary inlets or fill ports: a first inlet or fill port 507 and a second inlet or fill port 508. These fill ports serve as access points for filling the food storage chamber 503 with liquid, and they provide different methods for connecting external feeding systems or filling the food storage chamber 503 manually. The first fill port 507 may be positioned to facilitate attachment to a feeding line 504, which transports liquid from an external container to the food storage chamber 503. This design allows caregivers to connect the pacifier system to various types of liquid containers, creating a versatile and efficient feeding solution.

The first fill port 507 may be configured to connect with the distal end 506 of the feeding line 504 in a variety of ways. Examples of connection methods may include snap-fit mechanisms, threaded attachments, or friction-fit connectors. In one embodiment, the first fill port 507 and the distal end 506 of the feeding line 504 may have complementary threads, allowing the feeding line 504 to be securely twisted into the first fill port 507. This threaded connection offers stability and prevents accidental disconnection during feeding. Alternatively, a snap-fit design may be employed, where the distal end 506 of the feeding line 504 snaps into place within the first fill port 507. The snap-fit mechanism allows for quick and easy attachment or detachment, making it convenient for caregivers to assemble or disassemble the pacifier system without needing additional tools.

When the feeding line 504 is connected to the food storage chamber 503 through the first fill port 507, and when the proximal end connector 505 is attached to an external food pouch or container, the liquid or food flows smoothly from the container, through the feeding line 504, and into the food storage chamber 503. This setup enables the food storage chamber 503 to act as an intermediate reservoir, holding a certain amount of liquid that can be gradually dispensed to the infant through a nipple 501. For example, a caregiver may choose to fill the external container with a nutrient-rich liquid like milk or juice and then transfer it to the food storage chamber 503 using the feeding line 504 connected to the first fill port 507 of the food storage chamber 503.

Once the food storage chamber 503 is adequately filled with liquid food, the feeding line 504 can be removed from the first fill port 507 and the first fill port 507 can be closed using a cap or plug 509. The cap 509 serves as a secure closure, preventing any leakage or contamination of the liquid stored in the food storage chamber 503. The cap 509 may be designed to fit snugly over the first fill port 507, providing a reliable seal that keeps the contents fresh and uncontaminated. In some embodiments, the cap 509 may comprise a threaded design that twists into place, or a push-fit mechanism that allows it to press securely over the opening of the first fill port 507, This secure closure mechanism may particularly be advantageous for portable use, as it prevents spills or leaks while the pacifier 500 is carried or handled.

The second fill port 508 on the food storage chamber 503 provides an additional access point that allows caregivers to introduce specific liquids, such as medicine, supplements, or other essential nutrients, directly into the food storage chamber 503. The second fill port 508 may be designed to accommodate the insertion of a syringe, dropper, or similar liquid-delivery tool, making it especially convenient for administering precise quantities of medications or supplements without needing to mix them in an external food container (e.g., 106 in FIG. 3). This direct-access feature allows caregivers to add concentrated doses or specific amounts of liquid without disturbing the rest of the setup, offering a practical solution for situations where customized feeding is required.

For example, if an infant requires a small amount of liquid medication alongside their regular feeding, the caregiver can insert a syringe into the second fill port 508 and administer the exact dosage directly into the food storage chamber 503. The second fill port 508 may specifically be useful when the medicine needs to be kept separate from the main liquid, such as milk or juice, until the moment of feeding. By allowing for the direct insertion of a syringe or dropper, the second fill port 508 enables precise control over the quantity and concentration of the liquid being added. Caregivers can ensure that the correct amount of medication is administered without risk of dilution or loss in a larger container, which may particularly be beneficial for infants who need specific dosages based on their weight, age, or health condition.

The second fill port 508 may also be used in conjunction with the liquid delivered through the feeding line 504. For example, if the main liquid in the feeding line 504 is milk, the caregiver can add a vitamin supplement through the second fill port 508, mixing it directly in the food storage chamber 503. This setup allows for the supplement to be blended with the milk only at the point of consumption, preserving the freshness and potency of both substances. By mixing in the food storage chamber 503, caregivers avoid the need to pre-mix the entire liquid container, which may lead to nutrient degradation over time. Additionally, this method facilitates that the infant receives the supplement with each suck, distributing the combined liquid uniformly through the nipple 501.

This dual-filling mechanism also proves advantageous for feeding situations where different liquids must be administered sequentially or separately. For example, a caregiver may first introduce a small dose of medicine through the second fill port 508, allow the infant to consume it, and then proceed to deliver a more substantial quantity of milk or water via the feeding line 504. This setup allows for a controlled and organized feeding process, where the food storage chamber 503 acts as a central mixing point, adapting to various feeding requirements without needing multiple containers or devices.

The design of the second fill port 508 may also support snap-fit or push-fit mechanisms to secure the syringe or dropper, creating a stable point for administering the liquid without spillage. After the liquid has been added, a cap or plug (e.g., 509) may be used to close the second fill port 508, preserving the integrity and cleanliness of the chamber's contents. This ability to cap the fill ports after each use helps maintain hygiene and prevents contamination, especially when feeding outside of a sterile environment, such as during travel or outdoor activities.

Furthermore, the second fill port 508 adds a level of convenience for caregivers who may need to administer different types of liquids during a single feeding session. For example, if an infant needs both an electrolyte solution (e.g., oral rehydration solution-ORS) and a small amount of medicine, the electrolyte solution can be delivered through the feeding line 504, while the medicine can be added separately through the second fill port 508. This division allows for better control over the feeding session, as caregivers can monitor how much of each liquid the infant consumes. It also enables a gradual introduction of new supplements or medications, allowing caregivers to assess the infant's reaction before introducing additional doses.

The dual-inlet design with both the first fill port 507 and the second fill port 508 allows for versatile filling options. For example, caregivers may choose to fill the food storage chamber 503 through the feeding line 504 and the first fill port 507 when connecting to an external liquid container, or they may opt to use the second fill port 508 to manually fill the chamber with a syringe or dropper. This flexibility provides an adaptable feeding solution, enabling the pacifier 500 to accommodate various feeding contexts, such as at home, during travel, or in medical settings where precise dosage control is required.

The pacifier system 500 may also include a flow control valve 510 positioned within an opening 502A in the protective guard 502. The flow control valve 510 plays an important function in regulating the flow of liquid from the food storage chamber 503 (and consequently from the food container) through the nipple 501. This regulation facilitates that when the infant sucks on the nipple 501, the flow of liquid is controlled to prevent overwhelming the baby's swallowing ability. The presence of a flow control valve 510 provides caregivers with added control over the feeding process, allowing the liquid to be delivered at a manageable rate, which is both comfortable and safe for the infant.

The flow control valve 510 may be designed as a one-way valve, which allows liquid to flow in only one direction—from the food storage chamber 503 through the nipple 501. This one-way mechanism prevents any backflow of liquid into the food storage chamber 503, maintaining the freshness and sterility of the remaining liquid. The one-way function may particularly be beneficial in preventing contamination, as it facilitates that any saliva introduced by the infant's sucking does not travel back into the food storage chamber 503, keeping the stored liquid clean and uncontaminated for subsequent use.

The flow control valve 510 may be positioned strategically in the opening 502A of the protective guard 502, allowing it to regulate the liquid flow precisely as the infant applies suction on the nipple 501. When the infant sucks on the nipple, the suction pressure activates the one-way valve, allowing the liquid to pass through to the nipple 501. However, when the infant stops sucking or reduces suction, the flow control valve 510 automatically closes, preventing further liquid flow. This responsive mechanism helps control the pace of feeding, as the liquid is dispensed only when actively drawn by the infant, providing a more natural and gradual flow that mimics breastfeeding. This controlled flow reduces the risk of overfeeding or choking, especially for younger infants who may not yet have fully developed swallowing reflexes.

The design of the flow control valve 510 may vary depending on the specific requirements of the pacifier system. For example, in some embodiments, the one-way valve (507A) may use a silicone membrane or flap that opens only when suction is applied. This type of valve creates a seal when not in use, preventing liquid from leaking through the nipple 501 when the pacifier 500 is not being actively sucked on. Alternatively, the flow control valve 510 may be constructed with small slits or a duckbill design, which remain closed until suction is applied, then open to allow liquid to flow through. These design variations provide a simple yet effective way to control the flow of liquid, and their compact nature makes them ideal for integration within the protective guard 502.

The flow control valve 510 also enhances the portability and convenience of the pacifier 500. Since the flow control valve 510 prevents unintentional leakage, caregivers can transport the pacifier 500 with the food storage chamber 503 pre-filled, without worrying about spills. This leak-proof feature may be useful for caregivers who need a feeding solution that can be used on the go, as it allows the pacifier system to be kept in a bag or stroller without risk of leaking. When it is time to feed, the caregiver can simply offer the pacifier 500 to the infant, knowing that the liquid will flow only when the infant begins sucking.

Referring now to FIG. 5A, the illustration presents an exemplary baby pacifier 500A which incorporates a flow control valve 510 positioned within an opening 502A of the protective guard 502 in some embodiments of the present invention. The baby pacifier 500A is composed of several main elements, including a nipple 501, a protective guard 502, and a food storage chamber 503. The protective guard 502 serves a dual purpose of providing a safe and comfortable barrier that prevents the pacifier from being fully inserted into the infant's mouth while also housing the flow control valve 510 within its opening 502A. The flow control valve 510 is useful in regulating the flow of liquid food, medication, or other supplements from the food storage chamber 503 to the nipple 501, allowing a controlled and responsive feeding experience for the infant.

The flow control valve 510 is shown in an exploded view within FIG. 5A, providing insight into its structure and function. The flow control valve 510 may be positioned within the opening 502A, serving as a selective passageway that responds to the infant's sucking action. The flow control valve 510 may be constructed with one or more silicone membranes or flaps (indicated as 510A and 510B), which open and close in response to changes in pressure. When the infant sucks on the nipple 501, a gentle vacuum is created within the food storage chamber 503, causing the silicone flaps 510A and 510B to open. This opening allows the liquid stored in the food storage chamber 503 to flow through the flow control valve 510, passing into the nipple 501, and reaching the infant's mouth. The flexibility of the silicone material allows the silicone flaps 510A-510B to move effortlessly under suction, while also providing an effective seal when no suction is applied, thereby preventing leaks.

The silicone membranes or flaps 510A-510B may be constructed from a flexible, food-grade material, designed to operate as a one-way system, only allowing liquid to move in one direction-from the food storage chamber 503 to the nipple 501. This one-way function is integral for maintaining the integrity and freshness of the liquid in the food storage chamber 503 by preventing backflow. For example, when the infant stops sucking or releases pressure on the nipple 501, the silicone flaps 510A-510B automatically close, sealing off the opening 502A and preventing any liquid or air from flowing back into the chamber. This responsive action preserves the remaining liquid in the food storage chamber 503, keeping it clean and uncontaminated by external elements, which may particularly be beneficial in cases where the pacifier 500A is used intermittently over a longer period.

Furthermore, the flow control valve's 510 one-way design helps create a consistent flow rate tailored to the infant's natural sucking rhythm. The silicone flaps 510A and 510B open only when the infant applies suction, allowing the liquid to flow gradually, mirroring the experience of breastfeeding. This gradual flow not only provides comfort but also reduces the risk of overfeeding or choking, as the infant controls the intake rate. In some embodiments, the thickness and flexibility of the silicone flaps 510A-510B can be varied to adjust the resistance, offering caregivers the ability to select a valve that matches the infant's age and feeding habits. For example, younger infants with a weaker suckling reflex may benefit from a softer, more responsive valve, while older infants may require a valve with slightly more resistance.

The food storage chamber 503 in the pacifier system 500A may be designed to hold a predetermined and desired amount of liquid, such as milk, water, baby formula, breast-milk, or medication, which can be gradually dispensed through the flow control valve 510. The food storage chamber 503 may include a first fill port 507, which serves as an entry point for filling the food storage chamber 503 with the desired liquid. This first fill port 507 may include a one-way valve (indicated as 507A), which provides additional control and security during the filling process. The one-way valve 507A is designed to allow liquid to enter the food storage chamber 503 through the first fill port 507 without allowing it to leak back out, even if the pacifier 500A is moved or inverted after filling. This one-way mechanism is advantageous for maintaining a clean and convenient filling process, as caregivers can fill the food storage chamber 503 without worrying about spills or leaks.

The one-way valve 507A in the first fill port 507 operates similarly to the flow control valve 510 in terms of directionality. When liquid is introduced into the first fill port 507—whether through a syringe, dropper, feeding line, or small bottle—the one-way valve 507A allows it to flow directly into the food storage chamber 503. Once the desired amount of liquid is in the food storage chamber 503, the one-way valve 507A automatically closes, preventing any backflow. Such a design is highly practical, as it allows caregivers to pre-fill the pacifier 500A with liquid, seal it, and store it for later use. The one-way valve 507A also maintains the chamber's internal environment, preventing contaminants or air from entering, which is particularly beneficial for infants with specific feeding or medication schedules.

In some embodiments, the food storage chamber 503 may include more than one fill port, as discussed in FIG. 5. Multiple fill ports provide flexibility, allowing caregivers to add various liquids, such as medicine, vitamins, or supplements, in separate compartments or directly mix them in the food storage chamber 503. For example, a caregiver may use the first fill port 507 to add milk, while the second fill port (like 508 in FIG. 5) can be used to introduce a small amount of medication, facilitating that the liquid components are only combined when needed. Such a dual-port design offers enhanced customization, enabling caregivers to cater to specific dietary or medicinal requirements for the infant without needing to pre-mix everything in a separate container.

The flow control valve 510 and the first fill port 507 with one-way valve 507A together enhance the functionality and convenience of the baby pacifier system. These components allow the pacifier 500A to serve as both a comforting soother and an effective liquid delivery system, adaptable to various feeding scenarios. The one-way mechanisms in both valves provide a leak-proof and contamination-resistant feeding experience, allowing caregivers to prepare the pacifier 500A in advance and offer it to the infant at the appropriate time. This simplifies the feeding process, enabling the caregiver to control the flow and type of liquid administered to the infant, whether at home or on the go.

In some embodiments, the pacifier 500A is designed to function either with a feeding line (e.g., 504 or 104) attached to a liquid food pouch (e.g., 106) or as a standalone unit, providing flexibility for different feeding scenarios. When used with the feeding line, the pacifier 500A connects securely to the liquid pouch, allowing controlled, continuous feeding, ideal for feeding sessions where the caregiver can monitor flow and adjust as needed. Alternatively, the pacifier 500A can operate independently by filling the food storage chamber 503 in advance. This standalone setup is particularly convenient for times when the infant may be roaming around or during outings, as the food storage chamber 503 holds a pre-measured amount of desired liquid securely sealed with a plug (e.g., 509) to prevent leaks. This modular approach offers caregivers a portable, convenient feeding solution that adapts easily to both supervised feeding and mobile use, allowing the infant to enjoy a comfortable and uninterrupted feeding experience while on the move.

Referring now to FIG. 5B, the illustration presents an exemplary method of filling the food storage chamber 503 of a baby pacifier (referred to as 500B) using a syringe 511 in some embodiments of the present invention. The figure demonstrates how the pacifier system is designed to be efficiently filled with liquid or medicine 512 through a designated first fill-port 507. This configuration allows caregivers to introduce the desired liquid directly into the food storage chamber 503 in a controlled and precise manner, making the system particularly suited for infants requiring specific dosages or types of liquid, such as milk, juice, water, or liquid medication.

The first fill-port 507, located on the food storage chamber 503, provides an accessible entry point for the introduction of liquid or medicine 512 using a syringe 511. The syringe 511 may be equipped with a graduated scale, allowing caregivers to measure and administer an exact volume of liquid or medicine. This may be advantageous in scenarios where precise dosages are required, such as when delivering specific quantities of medication to infants or young children. The first fill-port 507 may be designed to accommodate various syringe sizes, providing flexibility in the amount of liquid that can be administered based on the infant's age or specific feeding requirements. The design of the first fill-port 507 facilitates that the liquid is directed solely into the food storage chamber 503, avoiding any risk of spillage or contamination during the filling process.

The liquid or medicine 512 introduced through the first fill-port 507 may be intended for immediate consumption or stored for later use, depending on the caregiver's needs. Once the liquid is in the food storage chamber 503, it becomes available for gradual dispensing through the nipple 501. The configuration of the first fill-port 507 and the food storage chamber 503 allows caregivers to prepare the pacifier system in advance, making it a convenient solution for on-the-go feeding. For example, a caregiver may pre-fill the food storage chamber 503 with milk before leaving home, so that the pacifier 500B is ready for use whenever the infant becomes hungry or needs soothing.

The syringe 511 is shown inserted into the first fill-port 507, which allows liquid or medicine 512 to flow directly into the food storage chamber 503. This direct connection minimizes the exposure of the liquid to air, reducing the risk of contamination and preserving the freshness and quality of the liquid. For example, when the syringe 511 is used to inject medication, the direct flow into the food storage chamber 503 allows the medication to remain potent and uncontaminated until the moment of consumption. This aspect of the invention may be valuable for infants with sensitive immune systems or those who require sterile feeding conditions.

In some embodiments, the first fill-port 507 may be equipped with a one-way valve, which permits the introduction of liquid from the syringe 511 while preventing any backflow from the food storage chamber 503. This one-way valve may be beneficial in maintaining the hygiene and integrity of the liquid stored in the food storage chamber 503, as it prevents external contaminants from entering the food storage chamber 503 once it has been filled. The one-way valve also supports the practical use of the pacifier system by allowing caregivers to store the pacifier 500B in any orientation without worrying about leaks. For example, when traveling, the pacifier 500B can be stored in a bag without the risk of spilling its contents.

Once the liquid or medicine 512 is introduced into the food storage chamber 503, it becomes accessible to the infant through the nipple 501 of the pacifier 500B. The liquid or medicine 512 flows from the food storage chamber 503 through an opening 502A in the protective guard 502, reaching the nipple 501 as the infant applies suction. This setup allows the infant to receive the liquid or medicine 512 in a controlled, measured flow, guided by the natural rhythm of their sucking. By providing a gradual and responsive delivery mechanism, the pacifier system emulates the natural breastfeeding experience, making it comforting and familiar to infants.

In some embodiments, the flow from the food storage chamber 503 to the nipple 501 through the opening 502A may be regulated by a flow control valve (e.g., 510 shown in FIG. 5A), which may be positioned within the opening 502A. This flow control valve 510 can be configured as a one-way valve that only opens when the infant applies suction, further controlling the liquid's flow rate and preventing unintentional leakage. The flow control valve 510 facilitates that the liquid or medicine 512 is dispensed only when actively drawn by the infant, reducing the risk of overfeeding, and enhancing the safety of the feeding experience.

The method shown in FIG. 5B illustrates the case and precision with which caregivers can administer specific liquids to infants using the pacifier system. The syringe 511 allows for accurate measurement, and the direct filling method minimizes the risk of dosing errors. This feature may be useful for infants with special dietary needs or those who require frequent medication, as it allows caregivers to efficiently manage and adjust the infant's intake without needing separate feeding equipment. For example, if an infant requires a combination of nutrients and a specific medicine, the caregiver can first administer the medicine through the first fill-port 507 and then follow up with a nutritional liquid, creating a customized feeding regimen in a single device.

The use of a syringe 511 to fill the food storage chamber 503 also offers significant advantages for caregivers seeking a sanitary feeding solution. Since the syringe 511 allows for direct, controlled filling, there is minimal need for handling the liquid or medicine 512, reducing the potential for contamination. The first fill-port 507 may be designed to fit securely around standard syringe tips, creating a stable and leak-proof connection during the filling process. This feature may be useful in healthcare settings or for infants with compromised immune systems, where maintaining a high standard of cleanliness is required.

In scenarios where different types of liquids need to be administered separately, the design of the first fill-port 507 in conjunction with the syringe 511 enables caregivers to introduce each liquid independently into the food storage chamber 503. For example, the caregiver may inject a small dosage of medicine first, allow the infant to consume it, and then refill the food storage chamber 503 with milk or water for hydration. This capability simplifies the feeding process, allowing caregivers to manage multiple liquids without needing multiple containers or feeding devices, which may be useful during travel or in other mobile settings.

Overall, FIG. 5B demonstrates a practical and efficient method for using the syringe 511 to fill the food storage chamber 503 of the baby pacifier system 500B. The direct filling mechanism, combined with the precision offered by the syringe 511, provides caregivers with a highly functional tool for administering a variety of liquids to infants, whether for nutrition, hydration, or medicinal purposes. The pacifier 500B, equipped with the food storage chamber 503 and first fill-port 507, represents an adaptable and hygienic solution that simplifies the feeding and medicating process for both caregivers and infants.

Referring now to FIG. 5C, the illustration presents an exemplary modular baby pacifier system 500C featuring a configuration with removably attachable components, as implemented in some embodiments of the present invention. The modular structure of the pacifier system 500C offers versatility and adaptability, allowing caregivers to interchange various components, including nipples of different sizes and food storage chambers of varying capacities. The pacifier system 500C provides a convenient solution for caregivers, offering customization based on specific feeding needs, settings, or liquid types.

The baby pacifier 500C comprises a protective guard 502, which serves as the central attachment point for the other components. The protective guard 502 features a removably attachable nipple 501A on its first side, positioned for direct use by the infant. On the opposite side, the protective guard 502 accommodates a removably attachable food storage chamber 503A. This dual-sided arrangement allows the food storage chamber 503A to supply liquid to the removable attachable nipple 501A through a controlled flow mechanism, creating a self-contained and efficient feeding system.

The protective guard 502 may further include one or more concentric circular orifices (marked as 513A and 513B) on the surface of its second side. The one or more concentric circular orifices 513A-513B serve as attachment points for the various food storage chambers, each with a diameter tailored to specific storage chamber sizes. The outermost circular orifice 513A may be designed with a larger diameter, allowing it to accommodate larger food storage chambers such as 503A. This adaptability is useful when larger quantities of liquid, like milk or juice, are needed, especially for extended feeding sessions or for older infants with greater intake capacity. The outermost circular orifice 513A provides a secure and stable connection, supporting the weight of larger storage chambers and preventing detachment during feeding.

The second circular orifice 513B has a smaller diameter than the outermost circular orifice 513A, enabling it to support smaller food storage chambers like 503B. The smaller orifice 513B may be particularly suitable for situations where a more compact storage chamber is required, such as when administering small doses of medicine or concentrated supplements. The different diameters of the one or more concentric circular orifices 513A-513B allow caregivers to select a storage chamber size appropriate for the type and amount of liquid being used, adapting the pacifier to suit various feeding contexts.

The protective guard 502 may also feature additional concentric circular orifices of varying diameters to accommodate other sizes of food storage chambers, such as 503C. Each of these orifices may be designed to securely hold a specific storage chamber, enabling a customized feeding solution that caters to diverse needs. For example, a caregiver may use the largest food storage chamber 503A for water during outdoor activities, while the smaller food storage chamber 503B may be used to carry a concentrated dose of medication for immediate administration. This modular approach provides a high degree of flexibility, allowing the caregiver to prepare and use the pacifier system 500C in different environments with minimal hassle.

The food storage chambers 503A-503C can be connected to the various concentric circular orifices (513A-513B) in multiple ways, including snap-fit mechanisms or rotate-and-lock mechanisms. A snap-fit connection allows the storage chamber to be pressed into the orifice until it clicks securely in place, making assembly and disassembly quick and easy without requiring additional tools. This design may be advantageous for caregivers who may need to switch storage chambers frequently, as it allows them to change chambers effortlessly based on the infant's needs. Alternatively, a rotate-and-lock mechanism may be implemented, where the storage chamber is inserted into the circular orifice and then twisted to lock it securely in place. This method provides a more robust attachment, making it ideal for larger food storage chambers or for use in active environments where stability is paramount.

On the first side of the protective guard 502, different sizes of nipples (identified as 501A-501D) may also be removably attached. Each nipple size is designed to cater to infants at different developmental stages, offering varied flow rates and textures that align with their growth and feeding patterns. For example, the smallest nipple 501B may be ideal for newborns, as it offers a gentle flow and a soft texture that mimics breastfeeding. As the infant grows, caregivers can replace the nipple 501B with progressively larger sizes, such as 501C, 501D, or 501A, each designed with an appropriate flow rate and material firmness to match the infant's increasing sucking strength and nutritional needs.

The interchangeable nipple design allows caregivers to select the most suitable nipple for the infant's current stage, without needing to purchase an entirely new pacifier system. For example, while traveling, caregivers can prepare multiple nipples in advance, each with specific characteristics that meet the infant's needs in different scenarios. The nipples 501A-501D may connect to the protective guard 502 (on the first side) through similar methods used for connecting the food storage chambers 503A-503C, such as snap-fit or twist-and-lock mechanisms, offering a stable yet easily removable attachment.

In some embodiments, different nipples (501A-501D) can be connected to the first side of the protective guard 502 using a threaded attachment mechanism similar to that found on standard milk bottles. Each nipple includes a base with external threads that align with corresponding internal threads on the first side of the protective guard 502. To attach, the caregiver simply aligns the nipple's threads with those on the protective guard 502 and twists it into place, securing the nipple firmly for use. This threaded connection provides a reliable and easy-to-use attachment that allows the nipple to remain securely in place during feeding, while also allowing for quick removal and replacement of nipples based on the infant's needs or preferred flow rate.

The modular structure of the baby pacifier system 500C allows for extensive customization, making it adaptable to a wide range of feeding situations. For example, during a day out, caregivers may choose a larger food storage chamber like 503A filled with milk and a medium-sized nipple like 501C, so that the infant has a consistent source of nutrition throughout the outing. At home, a smaller food storage chamber such as 503C with a specialized liquid (e.g., electrolyte solution) may be used, while a faster-flow nipple like 501D may be attached to provide hydration quickly and efficiently.

The pacifier system's modular design not only enhances convenience but also extends the lifespan of the device, as caregivers can continue to use the same protective guard 502 and update only the nipples 501A-501D and food storage chambers 503A-503C as the infant grows. This approach minimizes waste and offers a cost-effective solution by allowing caregivers to adapt the pacifier system 500C to the infant's changing needs without purchasing an entirely new product. The ability to interchange parts provides a sustainable approach, making the pacifier system 500C both environmentally friendly and economical.

In some embodiments, the pacifier (e.g., 500, 500A-500C) for feeding liquid food, medication, or water to a child comprises a protective guard, a nipple attached to the protective guard, a ring for gripping, a feeding line, and a flow controller. The nipple, attached to the first side of the protective guard 502, is made of a soft, flexible material such as medical-grade silicone or latex, providing a comfortable feel, and simulating the softness of natural feeding options. The protective guard itself may be made from a rigid material to prevent the pacifier from being fully inserted into the child's mouth, enhancing safety. Additionally, the protective guard 502 may have a soft, contoured surface on its first side so that it rests comfortably against the child's mouth. For further comfort, the protective guard 502 may be equipped with ventilation holes to promote airflow around the child's mouth, which can reduce skin irritation during extended use.

The second side of the protective guard 502 may comprise a ring for providing the child with a secure grip, enabling easy handling, and reducing the likelihood of the pacifier being dropped. This ring may be connected to the protective guard 502 in such a way that it can be removed if needed, as the protective guard 502 is designed with concentric circular orifices (513A-513B) on both the first and second sides to accommodate detachable components. In some configurations, the ring can be replaced by a food storage chamber (e.g., 503A-503C) that nests into the second side of the protective guard 502. The food storage chamber can be swapped for different sizes, depending on the feeding requirements of the child, offering flexibility for caregivers who need to adjust the volume based on the type and amount of liquid.

The feeding line connects a liquid container, such as a food or medicine pouch, to an opening in the protective guard 502, enabling liquid transfer to the nipple. The feeding line may be made of a flexible, medical-grade material that allows bending without kinking, thus providing a steady and uninterrupted flow of liquid. At the end of the feeding line, a connector is configured to securely attach to the liquid container. This connector may include a sharp, piercing tip for puncturing the seal of a liquid container or may be threaded to securely attach to containers with compatible openings. Alternatively, the connector may include a Luer lock for a secure, sterile connection.

The pacifier may also feature a flow controller integrated into the feeding line. The flow controller may include a clamp or dial mechanism, allowing caregivers to precisely adjust the liquid flow from the container to the nipple, catering to the child's preferred feeding pace. The flow controller may also be equipped with a drip chamber, allowing caregivers to visually monitor the liquid's flow through the feeding line, providing an adequate and safe feeding rate. In addition, the pacifier can include a flow control valve 510 positioned at either the mouth of the liquid container or at the protective guard opening. This valve regulates liquid flow towards the nipple and may include a one-way valve in the first fill port of the food storage chamber to prevent backflow, maintaining hygiene and liquid integrity.

The food storage chamber, which may optionally be detachable, is hemispherical in shape and configured to nest within the protective guard 502 on the second side. It is designed to temporarily store the liquid delivered through the feeding line, acting as an intermediate reservoir before the liquid reaches the nipple. The storage chamber may include multiple fill ports, allowing the caregiver to add liquids directly to the chamber as needed. For example, one fill port can be connected to the feeding line, while a second fill port allows for the introduction of medication using a syringe or dropper, providing flexibility to administer medicine alongside feeding.

Each fill port in the food storage chamber may be equipped with a plug to prevent leaks, enabling mobile use of the pacifier so the child can move freely without risking liquid spillage. The chamber thus retains the liquid securely during use, making it suitable for situations where the child may be actively playing or moving around. A protective cap can be attached to either side of the protective guard 502. When attached to the first side, the cap covers the nipple to maintain hygiene when not in use; alternatively, the cap can cover the second side of the protective guard 502, protecting either the ring or the food storage chamber when the pacifier is in use.

The liquid container used with the pacifier may be made from BPA-free plastic or medical-grade silicone to provide safe storage of liquids. Additionally, the system allows caregivers to customize the setup based on specific feeding needs by choosing different types and sizes of nipples, storage chambers, and feeding lines. This modular design offers a safe, hygienic, and adaptable feeding solution for infants, addressing various caregiving scenarios, whether at home, on the go, or for special feeding needs.

The modular pacifier system 500C is designed to allow for easy cleaning after each use. In some embodiments, each component of the pacifier system 500C, including the nipple (501A-501D), protective guard 502, food storage chamber (503A-503C), feeding line (504), and connector, can be easily detached. This modular design enables caregivers to disassemble the pacifier system 500C quickly, making it possible to clean each component thoroughly and individually. Once cleaned, the components can be reassembled securely, so that the pacifier remains hygienic and safe for the infant's next use.

In some embodiments, the pacifier system 500C can be packaged and sold as a “Newborn Necessity Kit,” offering a comprehensive solution for parents and caregivers. The kit may include multiple detachable components of the pacifier system 500C, such as interchangeable nipples of varying flow rates, a detachable food storage chamber, multiple feeding lines, and connectors compatible with standard liquid food pouches. Additionally, the kit may include a strap for securing the pacifier, a protective cap to keep the nipple clean, and a sterilization container for easy sanitation. By providing these components in a single package, the Newborn Necessity Kit offers a versatile and convenient feeding solution designed to meet the evolving needs of infants from newborn stages onward.

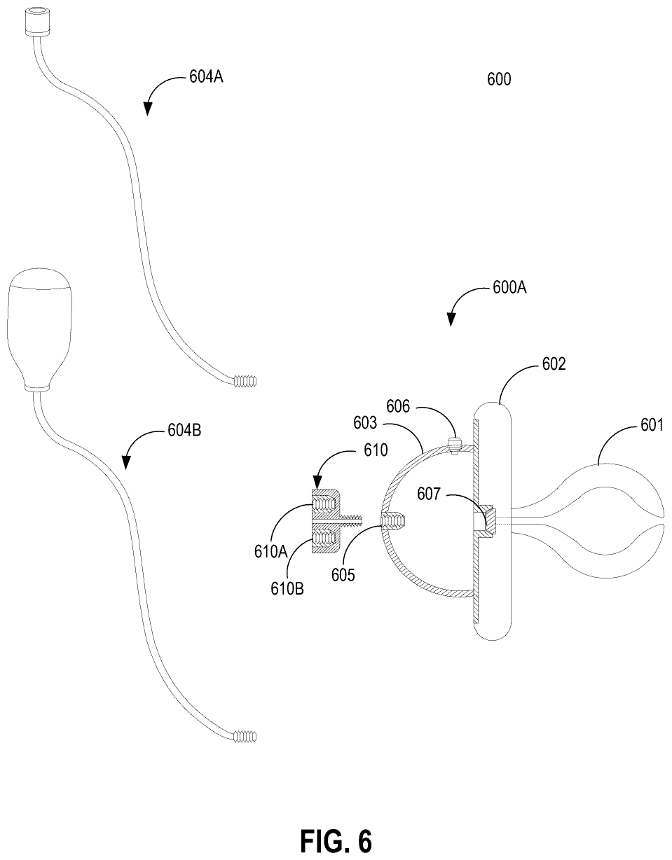

Referring now to FIG. 6, the illustration presents an exemplary baby pacifier system 600, incorporating a multi-port connector for connecting multiple feeding lines from different liquid food containers to a baby pacifier 600A in some embodiments of the present invention. The baby pacifier system 600 allows for a versatile feeding configuration where multiple types of liquids, such as milk, water, juice, or medications, can be administered through the same baby pacifier system 600. By facilitating the mixing or sequential feeding of different liquids, the design provides caregivers with a flexible and customizable feeding solution that can adapt to a variety of infant nutritional and medicinal needs.

The baby pacifier 600A includes several components, such as a nipple 601, a protective guard 602, and a food storage chamber 603. The protective guard 602 not only functions as a safety measure, preventing the pacifier from being fully inserted into the infant's mouth, but also serves as a base for attaching the other components. The food storage chamber 603, positioned behind the protective guard 602, acts as a reservoir for the liquid that is gradually dispensed to the infant through the nipple 601. The food storage chamber 603 is designed to hold liquids safely and deliver them in a controlled manner.

The food storage chamber 603 includes two primary fill ports: a first fill port 605 and a second fill port 606. Each fill port serves a unique function, allowing caregivers to use the baby pacifier system 600 for different types of feeding requirements. The second fill port 606 may be designed for the administration of small doses of liquid, such as medication or concentrated nutrients, which can be introduced into the food storage chamber 603 using a syringe or dropper. This fill port may be useful in cases where precise dosing is required, such as when administering medication to an infant who needs specific quantities based on age or weight. The second fill port 606 allows the caregiver to add liquid directly into the food storage chamber 603 without affecting any liquid already present, creating a controlled and clean filling process.

In contrast, the first fill port 605 may be used for direct connection to a feeding line, such as 604A or 604B, enabling a continuous flow of liquid into the food storage chamber 603. The first fill port 605 may be designed to accommodate various types of feeding lines (e.g., 604A-604B), making it adaptable for different feeding containers or liquid sources. For example, a caregiver can connect feeding line 604A to a bottle of milk while using feeding line 604B to deliver water or juice, allowing for flexible feeding options. The first fill port 605 thus serves as the main point of entry for primary feeding liquids, making it a versatile component for the baby pacifier system 600.

In some embodiments, a multi-port connector 610 may be utilized to connect multiple feeding lines (e.g., 604A-604B) to the first fill port 605. The multi-port connector 610 includes two or more feeding line ports, such as feeding line port 610A and feeding line port 610B, allowing different feeding lines to be attached simultaneously. For example, the feeding line port 610A can be connected to feeding line 604A, while feeding line port 610B can be connected to feeding line 604B. Each feeding line can be further attached to a separate food container, allowing caregivers to manage and mix various liquid types for feeding.

The feeding line 604A may be connected to a food container that holds one type of liquid, such as milk, while feeding line 604B may be connected to a different food container containing another type of liquid, such as water or juice. This setup may be beneficial for caregivers who need to feed infants with different types of liquids, either sequentially or in combination. For example, an infant may start with a dose of milk through feeding line 604A, and then receive water from feeding line 604B. This method allows for easy alternation between liquids without requiring the caregiver to remove or replace feeding containers.

The multi-port connector 610 allows for the controlled mixing of two or more types of liquids within the food storage chamber 603. In scenarios where a combination of liquids is desirable, such as milk mixed with vitamins or baby formula combined with a liquid supplement, the caregiver can use both feeding lines 604A-604B to deliver the liquids simultaneously into the food storage chamber 603. The multi-port connector 610 enables the liquids to enter the food storage chamber 603 at the same time, promoting even mixing before the infant consumes them. This functionality may be valuable for infants with specific dietary requirements, as it allows caregivers to administer a balanced blend of nutrients tailored to the infant's needs.

In certain embodiments, the multi-port connector 610 may include more than two feeding line ports, allowing for even greater flexibility in liquid combinations. For example, a three-port connector may support milk, water, and an electrolyte solution, each delivered through its dedicated feeding line. This expanded multi-port design provides caregivers with additional customization, enabling them to create specific feeding regimens for infants with complex nutritional or medicinal needs. This may particularly be beneficial in medical or healthcare settings, where precise feeding formulations are often required.

The feeding tubes or lines 604A and 604B may be connected to the multi-port connector 610 using various attachment mechanisms, such as threaded fittings, snap-fit connectors, or friction-fit designs. In a threaded fitting, the feeding lines 604A-604B can be twisted onto the connector ports, creating a secure and stable connection that prevents accidental disconnection during feeding. The snap-fit design, on the other hand, allows the feeding lines 604A-604B to click into place, making it easy to assemble and disassemble the system as needed. A friction-fit connection offers simplicity, allowing the feeding lines 604A-604B to be pressed onto the connector ports 610A-610B for a reliable seal.

The use of multiple feeding lines 604A-604B through the multi-port connector 610 provides significant benefits for caregivers managing different feeding scenarios. For example, during a long car ride, a caregiver may use feeding line 604A to deliver a continuous flow of milk, while intermittently using feeding line 604B to provide water for hydration. This approach enables the caregiver to switch between liquids without interrupting the feeding process, providing convenience, and reducing the infant's discomfort.

Another potential scenario involves the need to administer medicine mixed with liquid food. In this case, the caregiver can use feeding line 604A for a primary liquid, such as milk, and use feeding line 604B to introduce a liquid medication. The liquids can mix in the food storage chamber 603, allowing the infant to receive both the nutrition and medication simultaneously. This integrated feeding approach may be beneficial for infants who may resist direct administration of medication, as the mixed liquid is more palatable and easier to consume.

The multi-port connector 610 also allows caregivers to manage the flow rate and sequence of each liquid. For example, feeding line 604A may be adjusted to deliver a slower flow rate for milk, while feeding line 604B provides a faster flow for water. This flexibility may especially be useful for infants who prefer different liquids at varying speeds, as it allows caregivers to tailor the feeding experience to the infant's comfort and preferences.

Furthermore, the protective guard 602 of the baby pacifier system 600 may also include a flow control valve 607, which serves to regulate the flow of liquid from the food storage chamber 603 to the nipple 601. The flow control valve 607 may be configured as a one-way valve, allowing liquid to flow only in a single direction, from the storage chamber to the nipple, when the infant applies suction. The one-way design of the flow control valve 607 prevents backflow, facilitating that the liquid remains uncontaminated by external factors, such as saliva, and helping maintain the quality and hygiene of the stored liquid. By allowing liquid to pass only when actively drawn by the infant, the flow control valve 607 provides a controlled feeding experience, minimizing the risk of leakage and allowing caregivers to manage the infant's intake effectively, especially in cases where precise dosing or careful flow control is required.

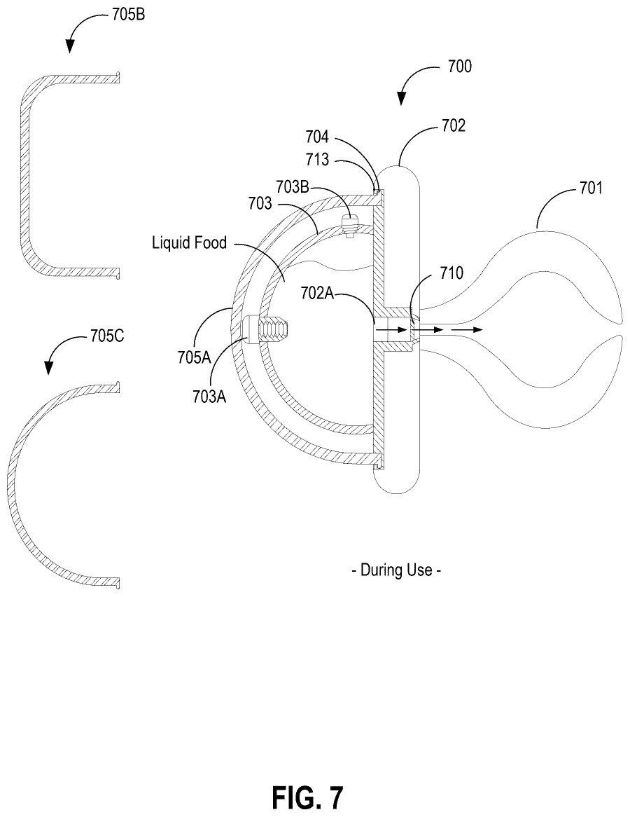

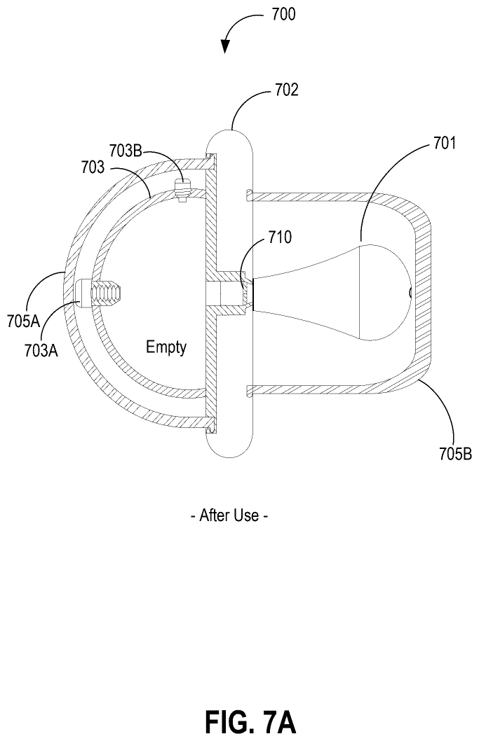

Referring now to FIGS. 7 and 7A, the illustrations depict exemplary embodiments of baby pacifiers that include protective caps for food storage chambers and nipples, designed to enhance both functionality and safety in various implementations of the present invention. FIG. 7 demonstrates a baby pacifier 700, comprising a nipple 701, a protective guard 702, and a food storage chamber 703. The food storage chamber 703 is structured to hold liquid food, which is then delivered to the infant through the nipple 701. The food storage chamber 703 may also incorporate one or more fill ports, as described in previous figures, allowing caregivers to conveniently introduce the liquid food into the food storage chamber 703. Once the liquid is filled, these fill ports can be securely closed using plugs, such as plugs 703A and 703B, thereby sealing the food storage chamber 703 and preventing any unintended leakage during use.

The protective guard 702 comprises a food flow opening 702A which is equipped with a flow valve 710 to control the flow of liquid food from the food storage chamber 703 into the nipple 701. The flow valve 710 is configured to open only when the infant applies suction to the nipple, allowing the liquid to flow gradually and at a controlled pace. By providing a regulated flow, the flow valve 710 helps maintain a smooth and comfortable feeding experience, preventing the infant from consuming too much liquid at once. This controlled dispensing may be beneficial for both feeding and hydration, enabling caregivers to use the pacifier for a variety of liquids, such as milk, water, or juice, depending on the infant's needs.

Once the liquid food has been introduced into the food storage chamber 703 through one of the fill ports, the caregiver can secure it by inserting the plugs 703A and 703B, creating a sealed environment within the food storage chamber 703. This sealing mechanism may be used when the infant is on the move, as it keeps the liquid contained within the food storage chamber 703, ready to be consumed as needed. With the fill ports properly closed, the pacifier 700 can be used by the infant while they move around, whether playing, resting, or traveling. Such a configuration allows the pacifier 700 to serve as both a soothing device and a portable feeding solution, reducing the need for separate feeding bottles or cups.

For added safety and protection, particularly during active use, the baby pacifier system includes a protective cap 705A that can be inserted into the circular orifice 713 on the protective guard 702. The protective cap 705A may be designed to shield the food storage chamber 703 from external impact or damage, while also safe guarding the infant from potential injury that could be caused by the plugs 703A and 703B during use. The protective cap 705A acts as a barrier, concealing the food storage chamber 703 and its components (e.g., plugs 703A-703B), thereby preventing any sharp or hard surfaces from making direct contact with the infant's mouth or face.

The circular orifice 713 on the protective guard 702 may be designed to securely hold the protective cap 705A, utilizing its circular edge 704 for a stable and snug fit. The circular orifice 713 may be the outermost orifice on the protective guard 702, or alternatively, it may have a larger diameter than the circular orifice that accommodates the food storage chamber 703. This configuration allows the protective cap 705A to envelop the food storage chamber 703 fully, covering it from all sides while providing sufficient space for the cap 705A to lock into position. The diameter of the food storage chamber 703 may be intentionally smaller than that of the protective cap 705A, allowing the cap 705A to encapsulate the food storage chamber 703 entirely without obstruction.

In terms of structure, both the food storage chamber 703 and the protective cap 705A may be designed as hemispherical components, enabling them to fit seamlessly within the circular orifice (e.g., 713) on the protective guard 702. This hemispherical design not only provides a smooth and uniform profile for the pacifier 700 but also enhances stability and security by creating a consistent shape that aligns with the contours of the protective guard 702. This alignment may be beneficial when the pacifier 700 is in use, as it prevents the components from becoming misaligned or dislodged due to the infant's movements.

Different protective caps, such as caps 705A, 705B, and 705C, can be selected based on the specific size and requirements of the food storage chamber 703, the protective guard 702, or the pacifier 700 itself. For example, when using a smaller storage chamber, a smaller protective cap like 705C may be chosen to achieve a precise fit within a corresponding circular orifice in the protective guard 702. Conversely, for a larger storage chamber that holds a greater quantity of liquid food, a larger cap such as 705B can be utilized. This modular approach allows caregivers to customize the pacifier system based on the infant's feeding needs, while also offering flexibility to adjust the setup as the infant grows.

The protective caps 705A-705C can vary not only in size but also in shape and material composition, providing a range of options to suit different feeding scenarios. For example, a soft silicone cap may be selected for infants who are teething, as it offers a gentle texture that reduces discomfort when the infant bites or chews on the pacifier 700. Alternatively, a rigid plastic cap may be used for added durability, making it ideal for outdoor activities or travel where the pacifier 700 may be exposed to rough handling. The availability of different protective cap materials enhances the versatility of the pacifier system, allowing it to be tailored to various environments and use cases.

The design of the protective cap 705A also facilitates easy attachment and removal, allowing caregivers to quickly swap caps 705A-705C based on the infant's current needs. For example, during a feeding session at home, the caregiver may opt for a lightweight cap like 705C that provides minimal protection but allows for easy access to the food storage chamber 703. When preparing for an outing, the caregiver can switch to a sturdier cap like 705B, which offers enhanced impact resistance to protect the food storage chamber 703 during transit. This adaptability makes the pacifier system suitable for both stationary and mobile feeding situations.

In addition to protecting the food storage chamber 703, the protective caps 705A-705C also provide a hygienic barrier that helps maintain the cleanliness of the liquid food stored inside. By covering the food storage chamber 703 and preventing direct exposure to external contaminants, the cap preserves the freshness and quality of the liquid, making it safe for the infant to consume. This feature is valuable when the pacifier is used outdoors or in public spaces, where the risk of contamination is higher. The protective cap thus serves as an effective shield against dust, germs, and other particles that may compromise the health and safety of the infant.

The protective cap's design also incorporates locking mechanisms to secure it firmly in place during use. For example, the circular edge 704 of the protective cap 705A may include snap-fit grooves that align with corresponding notches within the circular orifice 713, allowing the cap 705A to click securely into position. Alternatively, the cap 705A may feature a twist-lock mechanism, whereby the caregiver rotates the cap 705A to lock it within the orifice 713. These locking options enhance the stability of the protective cap 705A, preventing it from dislodging during feeding or transport, and providing peace of mind to caregivers regarding the safety of the pacifier system.

Referring now to FIG. 7A, the illustration showcases the baby pacifier 700 in a state of storage or after use, where a protective cap (e.g., 705B) is connected to the opposite side of the protective guard 702 to cover and protect the nipple 701. This embodiment enhances the functionality of the pacifier 700 by providing comprehensive protection to both the food storage chamber 703 and the nipple 701, thereby maintaining hygiene and safety when the pacifier is not actively in use.

The protective cap 705B is designed to fit securely over the nipple 701, attaching to the protective guard 702 on the side opposite the food storage chamber 703. This cap serves as a barrier against external contaminants such as dust, germs, and debris, which can accumulate on the nipple 701 when exposed to the environment. By enclosing the nipple 701 within the protective cap 705B, the pacifier 700 remains clean and ready for the next use, reducing the need for frequent washing or sterilization between feedings.

The attachment mechanism of the protective cap 705B to the protective guard 702 may be engineered for ease of use and reliability. The cap 705B may feature a circular edge (e.g., as 704) that aligns with a corresponding circular orifice (e.g., as 713) on the protective guard 702. This alignment allows the cap 705B to be inserted smoothly into the orifice, creating a snug fit that holds the cap 705B firmly in place. The connection may utilize a snap-fit design, where gentle pressure is applied to secure the cap onto the protective guard 702, or a twist-lock mechanism, where a slight rotation locks the cap into position. This secure attachment prevents the cap 705B from dislodging unintentionally, even if the pacifier 700 is stored in a bag or carried during travel.

The protective cap 705B not only safe guards the nipple 701 from contamination but also protects it from physical damage. The cap 705B provides a rigid or semi-rigid covering that shields the soft nipple material from compression, deformation, or tearing. This may particularly be beneficial when the pacifier 700 is packed among other items, such as in a diaper bag or purse, where it may be subjected to pressure or contact with sharp objects. By preserving the integrity of the nipple 701, the cap 705B extends the lifespan of the pacifier 700 and maintains its effectiveness for soothing and feeding.

In some embodiments, the protective cap 705B mirrors the design principles of the protective cap (705A) used for the food storage chamber 703. Both caps are crafted to complement the overall aesthetic of the pacifier 700, often matching in color, material, or shape to create a cohesive appearance. The hemispherical design of the caps contributes to a smooth and ergonomic profile, making the pacifier 700 comfortable to handle and less likely to snag on fabrics or other surfaces when stored.

The use of protective caps on both sides of the protective guard 702 transforms the pacifier 700 into a fully enclosed unit when not in use. This dual-cap configuration may be advantageous for maintaining hygiene during storage or transportation. For example, when an infant finishes using the pacifier 700, the caregiver can promptly attach the protective cap 705B over the nipple 701, preventing any residual saliva or liquid from coming into contact with external surfaces. This containment helps prevent the spread of germs and keeps the pacifier 700 clean for future use.

The materials selected for the protective cap 705B may be chosen for their durability, safety, and case of cleaning. Common materials include food-grade plastics or medical-grade silicones, which are non-toxic and resistant to bacterial growth. These materials are also lightweight, adding minimal bulk to the pacifier 700, and are often transparent or translucent, allowing caregivers to visually inspect the nipple 701 without removing the cap 705B. In some embodiments, the cap 705B may be opaque or colored, providing an opportunity for customization or to match the pacifier's design theme.

The protective cap 705B may also incorporate additional features to enhance its functionality. For example, the cap 705B may include ventilation holes to allow air circulation, preventing moisture buildup that could lead to mold or bacterial growth. Alternatively, the cap 705B may feature a clip or loop for attachment to a keyring or lanyard, making it convenient for caregivers to carry or locate the pacifier when needed. Some designs may even integrate a labeling area where caregivers can write the infant's name or other identifying information, which is useful in daycare or hospital settings to prevent mix-ups.

In practical use, the protective cap 705B simplifies the routine of caregivers by streamlining the process of storing and preparing the pacifier 700. After an infant finishes feeding or soothing with the pacifier 700, the caregiver can easily attach the cap 705B over the nipple 701, scaling it off from the environment. This quick action reduces the time and effort required to maintain the pacifier's cleanliness, allowing caregivers to focus on other tasks or attend to the infant's needs. When the pacifier 700 is needed again, the cap 705B can be swiftly removed, and the pacifier 700 is immediately ready for use without additional cleaning.

The presence of protective caps on both sides of the pacifier 700 also adds a layer of safety by minimizing the risk of choking hazards. With the nipple 701 and food storage chamber 703 covered, there are no small parts exposed that the infant could accidentally detach and ingest. This design consideration may be important for infants who are teething or prone to chewing on objects, as it prevents them from accessing components that could pose a danger.

The modular nature of the protective caps allows caregivers to interchange them based on specific needs or preferences. For example, a caregiver may choose a softer, more flexible cap for use at home, where the risk of impact is low, and a sturdier, more protective cap for travel or outdoor activities. This flexibility enhances the pacifier's adaptability to different environments and situations, making it a versatile tool in the caregiver's arsenal.

In some embodiments, the protective cap 705B may be designed with a self-standing feature, allowing the pacifier 700 to stand upright on a flat surface when both caps 705A-705B are attached. This may be useful for keeping the pacifier 700 readily accessible on a bedside table or countertop while maintaining cleanliness. The self-standing design also reduces the likelihood of the pacifier 700 rolling off surfaces or becoming misplaced.

The protective cap 705B may also be integrated with antimicrobial properties, utilizing materials infused with silver ions or other agents that inhibit bacterial growth. This enhancement provides an additional layer of protection against germs, which is particularly beneficial for infants with sensitive immune systems or during flu seasons. The antimicrobial feature works continuously to reduce microbial presence on the cap's surface, contributing to overall hygiene.

From a manufacturing perspective, the inclusion of protective caps like 705B allows for efficient production processes. The caps can be produced using similar molds and materials as the pacifier's other components, streamlining fabrication and reducing costs. This efficiency benefits both the manufacturer and the end-user, as it results in a high-quality product at a competitive price point.

In terms of design aesthetics, the protective cap 705B offers opportunities for customization and branding. Manufacturers can offer caps in various colors, patterns, or with embossed logos, allowing caregivers to personalize the pacifier 700 or coordinate it with other infant accessories. This personalization can make the pacifier 700 more appealing to caregivers and infants alike, enhancing user satisfaction.

The protective cap 705B also contributes to the longevity of the pacifier 700 by protecting the nipple 701 from environmental factors that could degrade the material over time. Exposure to sunlight, heat, or air can cause certain materials to deteriorate, affecting the nipple's performance and safety. By shielding the nipple 701 when not in use, the cap 705B helps preserve its integrity, extending the useful life of the pacifier 700.

In scenarios where the pacifier 700 is used in shared environments, such as daycare centers or hospitals, the protective cap 705B serves an important role in infection control. By keeping the nipple 701 covered when not in use, the cap reduces the risk of cross-contamination between infants. Caregivers can be confident that the pacifier 700 remains sanitary, even when stored alongside other items or in communal spaces.

The protective cap's ease of cleaning further enhances its practicality. Made from materials that are dishwasher-safe or easily sterilized, the cap 705B can be cleaned alongside other feeding accessories, simplifying the caregiver's cleaning routine. This convenience supports regular hygiene practices, which are required for infant health.

In some embodiments, a single protective cap (e.g., designated as 705A) may be designed to be versatile, allowing it to protect different components of the pacifier system depending on the usage context. During active use, the protective cap 705A can be attached to one side of the protective guard 702, specifically over the food storage chamber 703. By covering the food storage chamber 703, the cap 705A shields it from external contaminants and potential impacts, facilitating that the liquid food remains safe and uncontaminated while the infant uses the pacifier. The cap 705A also prevents the plugs or connectors of the food storage chamber 703 from coming into direct contact with the infant, enhancing safety during feeding.

After use, the same protective cap 705A can be removed from the food storage chamber side and re-attached to the opposite side of the protective guard 702 to cover the nipple 701. By switching the cap's position, caregivers can easily convert the pacifier 700 into a fully protected unit for storage or transportation. In this configuration, the cap 705A encloses the nipple 701, preventing it from exposure to dirt, germs, or any other contaminants that may compromise hygiene. This single-cap design provides a streamlined and practical solution, allowing caregivers to maintain the cleanliness of both the food storage chamber and the nipple without needing multiple caps.

This embodiment offers an efficient, cost-effective approach by minimizing the number of components required, reducing storage and maintenance needs, and simplifying the design. Caregivers benefit from the convenience of using a single cap that serves multiple protective functions, making it ideal for both stationary and on-the-go use. The ability to repurpose the protective cap 705A for either side of the pacifier system demonstrates a thoughtful, versatile design that caters to the dynamic needs of feeding and safe storage in various environments.

In some embodiments, a strap may be connected to the protective guard 702 of the pacifier 700. The strap may be designed to be worn comfortably around the neck of the infant, so that the pacifier 700 remains accessible while in use. The strap can be attached to the protective guard 702 via the circular orifice 713, which serves as a secure connection point. The same circular orifice 713 may also support the attachment of the protective cap 705A, allowing for both convenient access and hygienic storage. The strap itself may be adjustable, providing a custom fit for infants and reducing the risk of the pacifier 700 being dropped or misplaced during use.

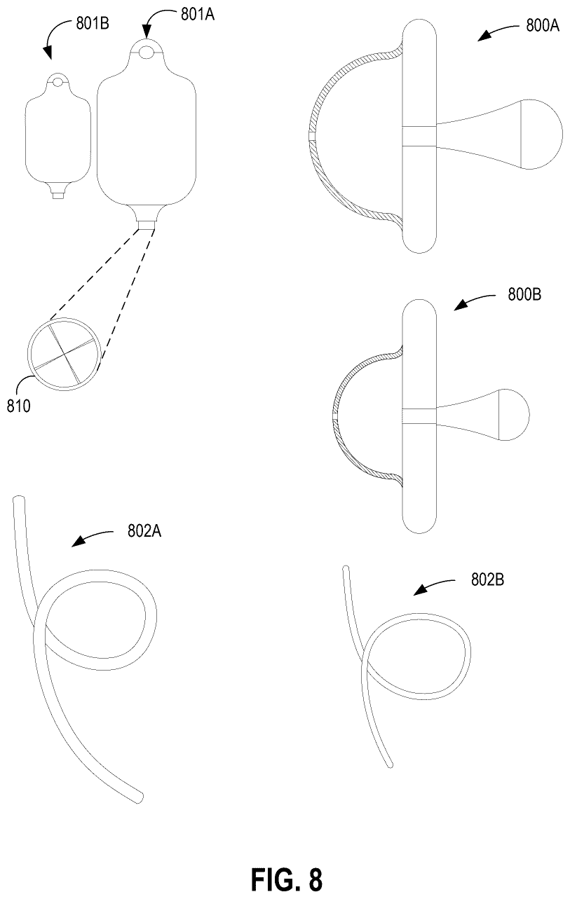

Referring now to FIG. 8, the illustration showcases various configurations and sizes of baby pacifiers, food pouches, and feeding tubes, as designed in some embodiments of the present invention. The baby pacifier system incorporates different types and sizes of pacifiers, exemplified here as pacifiers 800A and 800B, which reflect the flexibility and adaptability offered by the system. These variations accommodate different needs for feeding, soothing, and convenience, so that the pacifier system can adapt to infants of various ages and preferences. Pacifiers 800A and 800B may differ in aspects such as nipple shape, flow control, and size, catering to diverse requirements for both comfort and feeding effectiveness.

The pacifiers 800A and 800B may include different nipple shapes that mimic breastfeeding or bottle-feeding, designed to provide familiarity and comfort to the infant. For example, pacifier 800A may feature a rounded nipple, which is more conducive to infants used to breastfeeding, whereas pacifier 800B may have a more elongated nipple shape, suited for those accustomed to bottle-feeding. Variations in nipple softness, texture, and flexibility may also be incorporated, with materials such as medical-grade silicone or latex providing a safe and pleasant experience for the infant. These features allow the pacifier to fulfill both soothing and feeding roles effectively.

In addition to nipple shape and material, pacifiers 800A and 800B may include variations in flow rate, designed to control the amount of liquid dispensed per suck. This customization may be useful for infants of different ages, as younger infants may require a slower flow to avoid choking, while older infants can handle a faster flow for more efficient feeding. Adjustable flow control may be achieved through in-built flow regulators or interchangeable nipple designs that offer varying resistance levels, allowing caregivers to select the appropriate model based on the infant's needs.

The baby pacifier system may also be available in different sizes to suit the varying oral cavity sizes of infants at different stages of development. For example, a smaller pacifier 800B may be optimized for newborns, providing a more gentle and manageable feeding experience, while a larger pacifier 800A may be designed for older infants with a stronger suckling ability and larger oral cavity. This adaptability across different age groups facilitates that the pacifier system can grow with the infant, reducing the need for caregivers to switch to new products as the infant develops.

The baby pacifier system may further include different types, shapes, and sizes of food containers, such as food pouches 801A and 801B. These food pouches serve as portable reservoirs for storing liquid food, like milk, baby formula, juice, or water, and are designed to be compatible with the feeding tubes that connect them to the pacifiers. Food pouch 801A may represent a larger, higher-capacity option for extended feeding sessions, while food pouch 801B may offer a smaller, more compact form, suitable for short outings or as a backup feeding solution.

The food pouches 801A and 801B can be pre-filled with various types of liquid food and sold on the market, allowing caregivers to select ready-to-use options without needing to prepare the liquid themselves. For example, pre-filled pouches of milk, baby formula, or electrolyte solution can be easily attached to the feeding tube and used as needed. These pre-filled pouches offer a high level of convenience, especially for travel or outdoor use, as they eliminate the need for refrigeration or preparation on the go, providing an immediate feeding solution that maintains freshness and hygiene.

In some embodiments, the food pouches 801A and 801B may include an inbuilt flow control valve (designated as 810), which regulates the flow of liquid as it passes from the pouch into the feeding tube and subsequently into the pacifier. This inbuilt flow control valve 810 can be a one-way valve, allowing liquid to flow out of the pouch only when the infant applies suction through the pacifier, thereby preventing leakage or accidental spills. This design feature may be useful for portable feeding, as it enables caregivers to store the pouch in any orientation without worrying about unintended liquid loss.

The inbuilt flow control valve 810 may also provide adjustable flow rates to suit different feeding needs. For example, in scenarios where an infant requires a faster flow, the inbuilt flow control valve 810 can be set to allow a higher liquid output per suck, while a slower flow setting can be chosen for younger infants or thicker liquids. This adaptability in flow control helps caregivers manage the infant's intake, supporting safe and efficient feeding without the risk of overfeeding or choking.

Furthermore, the baby pacifier system may include various feeding tubes (identified as 802A and 802B), each featuring different lengths, diameters, and connector types to accommodate the diverse feeding requirements of infants. Feeding tube 802A may be designed as a longer tube, providing flexibility for caregivers who wish to keep the food pouch in a bag or stroller while the infant uses the pacifier. In contrast, feeding tube 802B may be a shorter variant, ideal for close, hands-on feeding sessions where the caregiver holds the pouch.

The diameter of the feeding tubes 802A and 802B may vary to support different flow rates and liquid types. For example, a wider diameter tube may be preferred for thicker liquids like formula or pureed foods, while a narrower tube may be used for thinner liquids such as water or juice. This customization allows the pacifier system to handle a range of liquid consistencies, catering to infants' diverse nutritional needs and preferences. Each tube's diameter can be chosen based on the specific liquid used, so that the flow remains consistent and manageable for the infant.

Each feeding tube (802A and 802B) may feature a food container connector at one end, designed to securely attach to the food pouch (801A or 801B), and a pacifier connector on the other end, which connects directly to the pacifier (800A or 800B). These connectors may utilize threaded, snap-fit, or friction-fit mechanisms to create a secure attachment, preventing disconnection during feeding. The reliable attachment mechanisms enable caregivers to feed infants without concerns about leakage or accidental detachment, making the system ideal for both stationary and mobile feeding scenarios.

The versatility offered by the feeding tubes 802A and 802B enables the pacifier system to be customized for various feeding environments. For example, during travel, a caregiver may prefer the longer feeding tube 802A to keep the food pouch stored out of sight, while at home, the shorter feeding tube 802B may be more practical for convenience. This adaptability supports a wide range of feeding styles, whether the infant is actively held by the caregiver or independently using the pacifier.

In certain embodiments, the feeding tubes 802A and 802B may be constructed from flexible, medical-grade silicone, which is durable, non-toxic, and easy to clean. This choice of material allows the tubes to remain safe for use with infants and resistant to wear, even with regular washing or sterilization. The flexibility of the silicone also allows the tubes to be bent or coiled without risk of kinking or clogging, providing an uninterrupted flow of liquid during feeding.

Moreover, the feeding tubes may include color-coding or marking along their lengths to help caregivers identify specific tubes for different liquids. For example, a red-marked tube may be designated for medications, while a blue-marked tube is used for water. This system of identification reduces the risk of cross-contamination and simplifies feeding routines, particularly for infants who require multiple types of liquids in a day.

The baby pacifier system's modular design allows caregivers to select the optimal combination of pacifiers, food pouches, and feeding tubes based on the infant's feeding requirements and the specific context of use. For example, a caregiver may choose a smaller pacifier 800B with a compact pouch 801B and short feeding tube 802B for quick feeding at home, while opting for a larger pacifier 800A with a high-capacity food pouch 801A and long feeding tube 802A for extended travel.

In some embodiments, a method for feeding liquid to an infant using a modular pacifier system involves a series of carefully designed steps to assemble, use, and maintain the pacifier based on the infant's specific feeding requirements. The process begins by selecting an appropriate pacifier size and configuration, taking into consideration the age and feeding needs of the infant. The pacifier system includes several components, such as a protective guard, a nipple, a food storage chamber, a feeding tube, and a liquid food pouch, all designed to provide a safe, efficient, and hygienic feeding experience.

The assembly of the pacifier starts with attaching the nipple to the first side of the protective guard, providing a soft, flexible surface that the infant can comfortably suck on to draw the liquid. The food storage chamber is then attached to the opposite second side of the protective guard, forming a secure connection that will allow liquid to pass from the storage chamber to the nipple through an opening in the protective guard. The food storage chamber serves as a reservoir for liquid food, juice, water, medication, or any other liquid the caregiver selects based on the infant's dietary needs.

Next, the feeding tube is prepared for connection to the liquid food pouch. The first end of the feeding tube is connected to the liquid food pouch via a sterile and leak-proof connector, which may include a sharp piercing tip, threaded or snap-fit mechanism for secure attachment. This connection is designed to maintain the sterility of the liquid and prevent any leakage during feeding. After securing the feeding tube to the pouch, the second end of the tube is connected to a fill port on the food storage chamber. This establishes a direct pathway for transferring the liquid from the pouch to the chamber. The feeding tube itself is made from a flexible material that resists kinking, allowing it to deliver an uninterrupted flow even if slightly bent or adjusted.

To manage the liquid flow, a flow controller integrated into the feeding tube is set to the desired rate. The caregiver can adjust this flow rate based on the infant's age or comfort level, using a dial, clamp, or similar mechanism to control the liquid flow from the food pouch to the storage chamber. Additionally, a first flow control valve in an opening of the liquid food pouch may be used to further regulate the liquid flow into the feeding tube. This dual regulation provides the caregiver with the flexibility to adjust the flow more precisely, so that the infant receives an appropriate amount of liquid with each feeding session.

Once the flow rate is set, the caregiver proceeds to fill the food storage chamber. This can be done in two ways: by allowing the liquid to flow from the liquid food pouch through the feeding tube into the chamber, or by directly introducing the liquid using a syringe or dropper through the fill port. This direct filling option is particularly useful for adding medications or supplements in precise amounts. The food storage chamber may also have multiple fill ports, allowing a second liquid, such as a medication or vitamin solution, to be introduced independently of the primary liquid. This setup facilitates combined feeding and medication administration, making it convenient for caregivers to address multiple feeding needs in a single session.

After filling, the fill port(s) of the food storage chamber are sealed with a plug to prevent leakage during use. This secure seal allows the pacifier to be used safely in different positions, even when the infant is actively moving or resting in various positions. With the plug in place, the caregiver attaches a first protective cap over the food storage chamber before placing the pacifier in the infant's mouth. This cap helps protect the chamber from accidental bumps or impacts during use, so that the feeding system remains secure and intact.

With the pacifier assembled and filled, the caregiver places it in the infant's mouth, allowing the infant to begin sucking on the nipple. An opening in the protective guard, positioned between the food storage chamber and the nipple, allows the liquid to flow from the chamber to the nipple. The flow of liquid is regulated by a second flow control valve positioned within this opening, which is configured to respond to the infant's sucking action. As the infant applies suction, the valve opens to release the liquid gradually, preventing a sudden rush of liquid that could lead to choking or discomfort. This design encourages a steady, controlled flow that mirrors natural feeding patterns.

Once the feeding session is complete, the caregiver removes the pacifier from the infant's mouth and can switch the first protective cap from the food storage chamber to the nipple side of the pacifier. This cap now serves as a hygienic cover for the nipple, keeping it clean until the next feeding session. This design provides added convenience for storage and transport, so that the nipple remains uncontaminated even when the pacifier is placed in a diaper bag or on a surface.

After each feeding session, the caregiver detaches and cleans the pacifier components, including the nipple, protective guard, food storage chamber, feeding tube, and protective cap. This cleaning process helps maintain the overall hygiene of the pacifier, especially important when dealing with milk or other perishable liquids. The detachable design of each component allows for easy sanitization, so that the system is safe for repeated use.

This modular pacifier system offers a flexible and customizable solution for feeding infants, accommodating various needs such as supplemental medication administration, adjustable flow control, and protective storage. With these features, caregivers can adapt the feeding method to suit the infant's developmental stage and specific dietary requirements, creating a comfortable and hygienic feeding experience.

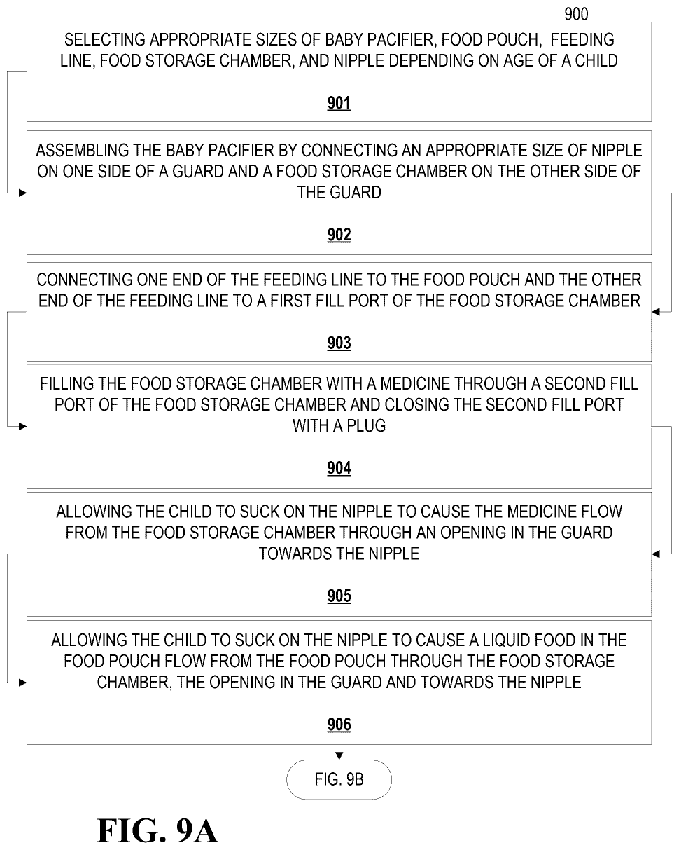

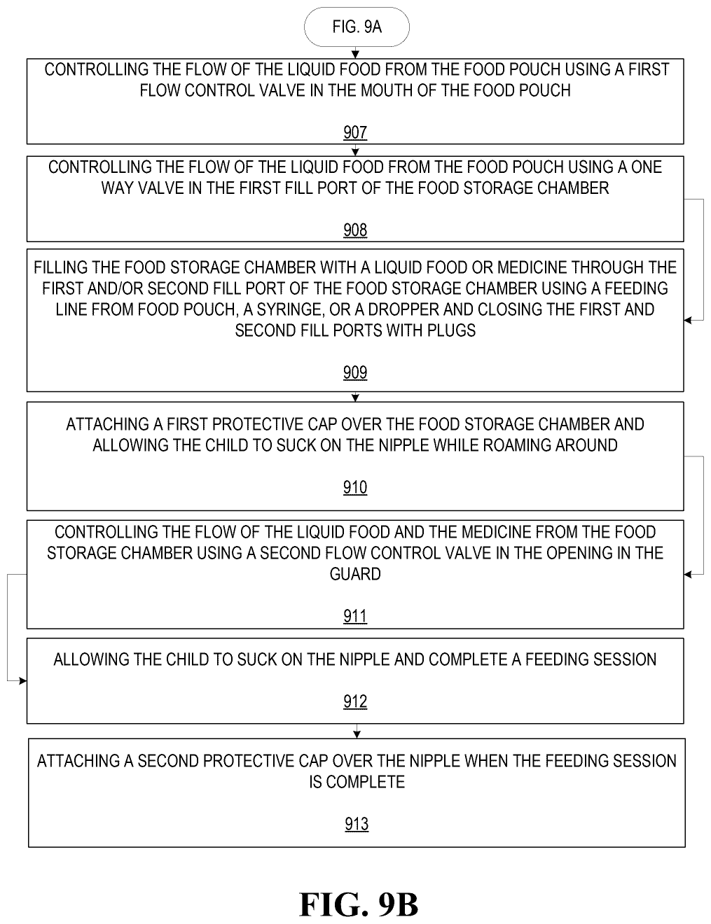

Referring now to FIGS. 9A-9B, an exemplary flowchart 900 outlines method steps for implementing various aspects of the baby pacifier system, as conceptualized in certain embodiments of the present invention. This flowchart 900 provides a step-by-step guide to configuring, assembling, and utilizing the pacifier system for effective and controlled feeding, taking into account the diverse needs of infants at different developmental stages. Each step in this flowchart 900 illustrates a specific action that caregivers can undertake to prepare, assemble, and administer liquid food or medicine to an infant using the inventive pacifier system. This method promotes flexibility and adaptability, allowing caregivers to customize the pacifier system based on the infant's age, dietary requirements, and specific feeding scenarios.

At step 901, the method begins with selecting appropriate sizes of the baby pacifier, food pouch, feeding line, food storage chamber, and nipple, considering the age and specific feeding requirements of the child. This selection process may be useful in facilitating that the components are suited to the infant's developmental stage, with smaller sizes generally chosen for younger infants and larger sizes for older infants. For example, a caregiver may select a smaller nipple and food storage chamber for a newborn who requires a gentle flow rate and limited liquid volume, while choosing larger components for a toddler who can handle a more substantial intake. Additionally, the caregiver may select a soft silicone nipple to mimic breastfeeding for newborns, while opting for a firmer nipple as the child grows accustomed to bottle feeding.

At step 902, the process involves assembling the baby pacifier by connecting an appropriate size of nipple on one side of a protective guard and a food storage chamber on the other side of the protective guard. This assembly step is crucial to create a complete pacifier system that enables controlled feeding through the nipple while securely holding the liquid food or medicine in the storage chamber. For example, the caregiver may attach a rounded nipple that resembles the shape of a mother's breast on one side of the protective guard, which could help soothe a breastfeeding infant. On the opposite side of the protective guard, the caregiver connects a hemispherical food storage chamber that aligns securely within a corresponding orifice on the protective guard, creating a stable and balanced configuration that the infant can use comfortably.

At step 903, one end of the feeding line is connected to the food pouch, and the other end of the feeding line is connected to a first fill port of the food storage chamber. This connection establishes a conduit that transfers liquid food from the food pouch into the storage chamber, allowing caregivers to control and replenish the liquid supply as needed. For example, the caregiver may connect a pre-filled food pouch containing milk to the feeding line, which then channels the milk into the storage chamber in preparation for feeding. The connection mechanisms, such as threaded or snap-fit attachments, provide a secure and leak-proof link between the feeding line and the respective components, allowing caregivers to handle the system confidently without worrying about accidental disconnections.

At step 904, the caregiver fills the food storage chamber with a measured dose of medicine through a second fill port of the food storage chamber and subsequently seals the fill port with a plug. This step is particularly beneficial for infants who require medication in addition to their regular feeding. By using the second fill port, the caregiver can introduce the precise dosage of medication without disturbing the liquid food already in the chamber. For example, if the infant needs a small dose of liquid vitamin, the caregiver can inject it through the second fill port using a syringe or dropper, then close the port with a plug to prevent leakage. This approach provides a hygienic and controlled way to administer medication along with food, reducing the stress of separate dosing for both the caregiver and the infant.

At step 905, the child is allowed to suck on the nipple to draw the medicated liquid from the food storage chamber through an opening in the protective guard, towards the nipple. This controlled flow allows the infant to receive the medicine as part of the natural sucking action, which can be less stressful than direct medication administration. The flow valve integrated into the protective guard's opening regulates the liquid flow, so that the medication is dispensed gradually rather than in one sudden release. This slow, regulated flow is especially helpful for infants who may otherwise resist taking medicine, as they can ingest the medication gradually and comfortably. The caregiver can observe the infant's behavior to facilitate that they are comfortably consuming the liquid through a familiar and soothing method.

At step 906, the child is again allowed to suck on the nipple, but this time to consume a liquid food stored in the food pouch, which flows through the feeding line, the food storage chamber, and towards the nipple. This step enables a continuous feeding experience that combines the benefits of a pacifier with the nutritional intake of liquid food, such as milk or formula. As the infant sucks on the nipple, the liquid food flows gradually from the pouch, through the feeding line and storage chamber, and into the nipple, offering a seamless and controlled feeding experience. The flow control valve at the protective guard's opening manages the rate of liquid release, making the pacifier suitable for different feeding speeds based on the infant's sucking strength and rhythm.

At step 907, the method involves controlling the flow of liquid food from the food pouch using a first flow control valve located in the mouth of the food pouch. This flow control valve enables precise management of the liquid flow rate from the pouch into the feeding line. For example, if the food pouch contains a thicker liquid like formula, the valve can be adjusted to allow a slower release, matching the infant's natural sucking rhythm, and preventing potential discomfort from an overwhelming flow. The flow control valve may utilize a mechanism similar to those found in IV setups, where the caregiver can dial in the exact flow rate needed for optimal feeding.

At step 908, the flow of liquid food from the food pouch to the pacifier is controlled further using a one-way valve located in the first fill port of the food storage chamber. This one-way valve allows liquid to enter the chamber without backflow, maintaining the integrity of the food and preventing contamination from saliva or other external factors. For example, as the infant sucks on the pacifier, the one-way valve facilitates the one-way flow of the liquid into the nipple and facilitates prevention of back flow into the feeding line or food pouch, creating a clean and safe feeding environment. The one-way valve can be constructed with a flexible membrane that opens under suction and closes automatically when suction stops, providing an uninterrupted, one-directional flow.

At step 909, the caregiver fills the food storage chamber with liquid food or medicine through either the first or second fill port, using a feeding line, syringe, or dropper. Once the desired liquid is introduced, the caregiver closes the fill ports with plugs to prevent leakage. For example, if the caregiver wishes to administer a specific dosage of medicine along with liquid food, they can use a syringe to insert the medication through the second fill port while keeping the food intact in the storage chamber. This allows for precise dosing without mixing the medication prematurely with the food. The plugs used to seal the fill ports are designed to create a leak-proof barrier, allowing the caregiver to handle the pacifier confidently, even in active or mobile situations.

At step 910, a first protective cap is attached over the food storage chamber, allowing the child to use the pacifier safely while roaming around. This protective cap serves as a barrier, covering the storage chamber and shielding it from impacts or accidental contact. For example, if the infant is crawling or playing, the cap prevents any hard components of the storage chamber, such as plugs, from coming into direct contact with the infant's face or hands. The cap may be made of a soft material like silicone, which provides a gentle touch and reduces the risk of injury. The design also adds to the pacifier's portability, as the caregiver can feel secure knowing the system is safe for the infant's active use.

At step 911, the flow of liquid food and medicine from the food storage chamber is further regulated using a second flow control valve located in the opening of the protective guard. This secondary valve provides an additional layer of flow control, allowing the liquid to pass through at a consistent rate that suits the infant's sucking ability. For example, a caregiver may set the flow control valve to a slower setting for younger infants who require a gentler flow. This control valve may feature an adjustable design, where the caregiver can modify the flow rate by twisting or pressing a dial, allowing flexibility in response to the infant's specific feeding needs.

At step 912, the child is allowed to suck on the nipple and complete a feeding session. During this step, the infant receives the liquid food and any added medication through a controlled flow, facilitated by the combined mechanisms of the storage chamber, feeding line, and valves. The nipple's shape and material are chosen to provide a comforting, natural feel, helping to keep the infant calm and engaged during feeding. This step allows the caregiver to monitor the infant's feeding behavior, making adjustments as needed to accommodate the infant's pace and preference. The controlled flow facilitates that the feeding session is smooth and without interruptions, as the liquid is delivered at a rate suited to the infant's ability.

At step 913, once the feeding session is complete, a second protective cap is attached over the nipple to maintain hygiene and protect the nipple from damage or contamination. This second cap is particularly useful when the pacifier is stored for later use, as it shields the nipple from external elements like dust or dirt. The protective cap can be easily attached and detached, allowing caregivers to maintain cleanliness without additional effort. For example, if the pacifier is placed in a diaper bag or on a surface, the cap prevents the nipple from direct exposure, preserving its integrity for the next feeding session. This step concludes the feeding process, facilitating that the pacifier is safely stored and ready for subsequent use.

These steps collectively provide a structured approach to using the pacifier system, addressing each aspect of preparation, feeding, and storage in a methodical and efficient manner. This detailed flowchart serves as a comprehensive guide for caregivers, offering clear instructions on how to optimize the use of the pacifier system for safe and effective feeding. The modularity and adaptability of the components enable caregivers to customize the system according to the infant's specific needs, making it a versatile solution for infant feeding and care.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, separation of various system components in the embodiments described above should not be understood as requiring such separation in all embodiments, and it should be understood that the described program components and systems can generally be integrated together in a single hardware and/or software product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A pacifier for feeding liquid food, medication, or water to a child, the pacifier comprising:
a nipple configured to deliver a liquid to mouth of the child;
a protective guard comprising a first side and a second side, wherein the nipple is attached to the first side of the protective guard, and wherein the protective guard prevents the pacifier from being fully inserted into the mouth of the child;
a ring connected on the second side of the protective guard for providing a grip for the child;
a feeding line comprising a first end attached to an opening in the protective guard and a second end comprising a connector configured to connect with a liquid container; and
a flow controller integrated into the feeding line for regulating a flow of the liquid from the liquid container to the nipple.

2. The pacifier of claim 1, wherein the nipple is made of a soft, flexible material selected from a group consisting of a medical-grade silicone and latex.

3. The pacifier of claim 1, wherein the protective guard is made of a rigid material to provide a secure positioning of the pacifier during use.

4. The pacifier of claim 1, wherein the feeding line is made from flexible, medical-grade material, allowing the feeding line to bend without kinking for providing an uninterrupted flow of the liquid.

5. The pacifier of claim 1, wherein the connector at the second end of the feeding line comprises a sharp piercing tip configured to penetrate a seal of the liquid container, thereby establishing a secure and sterile connection.

6. The pacifier of claim 5, wherein the connector comprises a Lure lock connector.

7. The pacifier of claim 1, wherein the connector on the second end of the feeding line comprises a threaded connection, allowing for secure attachment to the liquid container with a corresponding threaded opening.

8. The pacifier of claim 1, wherein the protective guard comprises a soft, contoured surface on the first side to comfortably fit against the mouth of the child during use.

9. The pacifier of claim 1, the protective guard comprises ventilation holes to enhance airflow around the mouth of the child, reducing skin irritation and enhancing comfort during use.

10. The pacifier of claim 1, wherein one or more of: the nipple, the ring, and the feeding line are detachable from the protective guard.

11. The pacifier of claim 10, wherein the protective guard comprises concentric circular orifices on one or both of the first side and the second side of the protective guard.

12. The pacifier of claim 11, wherein the protective guard comprises a circular orifice on the second side of the protective guard for removably attaching the ring to the second side of the protective guard.

13. The pacifier of claim 12, wherein a food storage chamber is configured to be removably attached to the circular orifice on the second side of the protective guard instead of the ring.

14. The pacifier of claim 13, wherein the food storage chamber is configured as a removable component that can be detached and replaced with a different chamber size based on feeding requirements.

15. The pacifier of claim 14, wherein the food storage chamber is configured to receive and temporarily store the liquid delivered through the feeding line before release to the nipple.

16. The pacifier of claim 15, wherein the food storage chamber comprises one or more fill ports for introducing additional liquid directly into the food storage chamber.

17. The pacifier of claim 16, wherein the food storage chamber comprises a first fill port to be connected to the feeding line, and a second fill port to receive a medication using a syringe or a dropper.

18. The pacifier of claim 17, wherein the first fill port and the second fill port are each configured to be securely closed with plugs, enabling the food storage chamber to retain the liquid securely for mobile use, allowing the child to move freely while using the pacifier.

19. The pacifier of claim 13, wherein the food storage chamber is hemispherical and designed to nest within the second side of the protective guard when attached.

20. The pacifier of claim 19, further comprising a protective cap configured to attach to the protective guard on the first side of the protective guard, covering the nipple when not in use to maintain hygiene.

21. The pacifier of claim 20, wherein the protective cap is configured to attach to the protective guard on the second side of the protective guard, covering the ring or the food storage chamber when the pacifier is in use.

22. The pacifier of claim 21, further comprising a flow control valve positioned in at least one of the following locations: an opening of the food storage chamber and the opening in the protective guard, the flow control valve comprises silicon flaps configured to regulate liquid flow towards the nipple.

23. The pacifier of claim 18, further comprising a one-way valve in the first fill port of the food storage chamber, the one-way valve is configured to permit liquid flow into the food storage chamber while preventing backflow.

24. The pacifier of claim 1, wherein the flow controller comprises a clamp or dial mechanism to allow precise adjustment of the flow of the liquid from the liquid container to the nipple.

25. The pacifier of claim 1, further comprising a drip chamber integrated into the feeding line to allow visual monitoring of the flow of the liquid from the liquid container to the nipple.

26. The pacifier of claim 1, wherein the liquid container is made from BPA-free plastic or medical-grade silicone.

27. A modular baby pacifier for feeding liquid food or medicine to an infant, comprising:
a protective guard configured to prevent full insertion of the modular baby pacifier into mouth of the infant, the protective guard having a first side and a second side;
a detachable nipple attached to the first side of the protective guard, the detachable nipple is configured to allow a liquid to flow when the infant applies suction;
a detachable food storage chamber attached to the second side of the protective guard, the detachable food storage chamber defining an internal cavity for holding the liquid and having at least one fill port for introducing the liquid into the detachable food storage chamber;
a feeding tube with a first end and a second end, the first end configured to connect to a liquid food pouch and the second end configured to connect to the at least one fill port of the detachable food storage chamber, the feeding tube forming a conduit for transferring the liquid from the liquid food pouch to the detachable food storage chamber;
a connector positioned at the first end of the feeding tube, the connector configured to establish a sterile and leak-proof connection with the liquid food pouch; and
an opening in the protective guard, the opening positioned between the detachable food storage chamber and the detachable nipple and configured to allow the flow of the liquid from the detachable food storage chamber to the detachable nipple.

28. The modular baby pacifier of claim 27, further comprising a flow controller integrated into the feeding tube, the flow controller configured to regulate a flow rate of the liquid from the liquid food pouch to the detachable food storage chamber.

29. The modular baby pacifier of claim 27, further comprising a first flow control valve positioned within the at least one fill port of the detachable food storage chamber, the first flow control valve configured as a one-way valve to allow the liquid to enter the detachable food storage chamber from the feeding tube while preventing backflow.

30. The modular baby pacifier of claim 27, further comprising a second flow control valve positioned within the opening of the protective guard, the second flow control valve configured to control release of the liquid from the detachable food storage chamber to the detachable nipple in response to suction applied by the infant on the detachable nipple.

31. The modular baby pacifier of claim 27, further comprising a first protective cap configured to attach to the first side of the protective guard over the detachable nipple, and a second protective cap providing protection for the detachable nipple and maintaining hygiene after feeding sessions.

32. The modular baby pacifier of claim 27, further comprising a second protective cap configured to attach to the second side of the protective guard over the detachable food storage chamber, the second protective cap providing protection for the detachable food storage chamber and preventing contamination during non-use.

33. The modular baby pacifier of claim 27, further comprising interchangeable components, including multiple sizes and shapes of nipples, detachable food storage chambers, feeding tubes, and protective caps, allowing the modular baby pacifier to be customized based on an age of the infant or specific feeding needs.

34. The modular baby pacifier of claim 27, further comprising a multi-port connector configured to connect to the at least one fill port of the detachable food storage chamber, wherein the multi-port connector comprises two or more feeding line ports for connecting different feeding tubes from different food pouches.

35. A method for feeding a child using a pacifier, the method comprising:
filling a liquid container with a desired liquid selected from a group consisting of milk, juice, water, baby formula, breast milk, and medication;
securing a connector of a feeding line to the liquid container to provide a sterile and leak-proof connection;
attaching the feeding line to a nipple of the pacifier through a protective guard;
setting a flow controller integrated into the feeding line to a desired flow rate, providing precise regulation of a flow of the desired liquid;
placing the nipple of the pacifier in a mouth of the child;
monitoring the flow of the desired liquid through the feeding line and a drip chamber;
adjusting the flow controller based on sucking patterns and needs of the child; and
allowing the child to finish a feeding session.

36. The method of claim 35, further comprising a step of covering the nipple with a protective cap when not in use to maintain hygiene.

37. A method for feeding a liquid to an infant using a modular pacifier system, the method comprising the steps of:
a. selecting an appropriate size of a baby pacifier comprising a protective guard, a nipple, a food storage chamber, a feeding tube, and a liquid food pouch, based on an age and feeding needs of the infant;
b. assembling the baby pacifier by attaching the nipple to a first side of the protective guard and the food storage chamber to an opposite second side of the protective guard;
c. connecting a first end of the feeding tube to the liquid food pouch via a connector, creating a sterile and leak-proof connection;
d. connecting a second end of the feeding tube to a fill port of the food storage chamber, establishing a conduit for transferring the liquid from the liquid food pouch into the food storage chamber;
e. regulating a flow of the liquid from the liquid food pouch through the feeding tube using one or both of: a flow controller integrated into the feeding tube, and a first flow control valve in an opening of the liquid food pouch;
f. filling the food storage chamber with the liquid through the fill port by allowing the liquid to flow from the liquid food pouch via the feeding tube, or by introducing the liquid directly through the fill port using a syringe or dropper;
g. sealing the fill port of the food storage chamber with a plug after filling, preventing leakage during feeding;
h. positioning a second flow control valve within an opening in the protective guard, configured to control a release of the liquid from the food storage chamber to the nipple;
i. placing the baby pacifier in the infant's mouth, allowing the infant to suck on the nipple; and
j. delivering the liquid from the food storage chamber to the nipple through the opening in the protective guard, wherein liquid flow is regulated by the second flow control valve based on the infant's sucking action.

38. The method of claim 37, further comprising attaching a first protective cap over the food storage chamber during use of the baby pacifier to protect the food storage chamber and prevent accidental contact.

39. The method of claim 38, further comprising switching the first protective cap to the nipple side of the baby pacifier for hygienic storage of the nipple after a feeding session is completed.

40. The method of claim 39, further comprising cleaning detachable components of the baby pacifier, including the nipple, the protective guard, the food storage chamber, the feeding tube, and the first protective cap, after the feeding session.

41. The method of claim 40, wherein the food storage chamber comprises multiple fill ports, and the method further comprises introducing a second liquid through an additional fill port in the food storage chamber for combined feeding or medication administration.
